(19) United States
(12) Patent Application Publication
(10) Pub. No.: US 2017/0364844 A1
(43) Pub. Date: Dec. 21, 2017

(54) AUTOMATED-APPLICATION-RELEASE-MANAGEMENT SUBSYSTEM THAT SUPPORTS INSERTION OF ADVICE-BASED CROSSCUTTING FUNCTIONALITY INTO PIPELINES

(71) Applicant: VMWARE, INC., Palo Alto, CA (US)

(72) Inventor: RISHI SARAF, Bengaluru (IN)

(21) Appl. No.: 15/437,450

(22) Filed: Feb. 21, 2017

(30) Foreign Application Priority Data
Jun. 16, 2016 (IN) 201641020659

(51) Int. Cl. G06Q 10/06; H04L 29/08; G06F 17/30

(52) U.S. Cl. CPC G06Q 10/0633; G06F 17/30094; H04L 67/10

(57) ABSTRACT

The current document is directed to automated-application-release-management facilities that support aspect-oriented-programming-like insertion of plug-in-implemented advice into release pipelines. In a described implementation, advice is represented by entries in an advice set or aggregation. These entries encode rules, advice types, and references to advice-implementing plug-ins. During release-pipeline execution, calls to the advice-implementing plug-ins are inserted prior to and after tasks in workflows corresponding to the tasks that are then executed by a workflow-execution engine. Rules may include release-pipeline parameters and advice definitions may use wildcard characters and other elements of regular expression in pipeline, stage, and task names.

### RELATED APPLICATION

Benefit is claimed under 35 U.S.C. 119(a)-(d) to Foreign Application Serial No. 201641020659 filed in India entitled “AUTOMATED-APPLICATION-RELEASE-MANAGEMENT SUBSYSTEM THAT SUPPORTS INSERTION OF ADVICE-BASED CROSSCUTTING FUNCTIONALITY INTO PIPELINES”, filed on Jun. 16, 2016, by VMware, Inc., which is herein incorporated in its entirety by reference for all purposes.

### TECHNICAL FIELD

The current document is directed to automated-application-release-management facilities and, in particular, to a highly modularized automated-application-release-management facility into which crosscutting functionality is introduced by advice-based methods and subsystems.

### BACKGROUND

Early computer systems were generally large, single-processor systems that sequentially executed jobs encoded on huge decks of Hollerith cards. Over time, the parallel evolution of computer hardware and software ware produced main-frame computers and minicomputers with multi-tasking operation systems, increasingly capable personal computers, workstations, and servers, and, in the current environment, multi-processor mobile computing devices, personal computers, and servers interconnected through global networking and communications systems with one another and with massive virtual data centers and virtualized cloud-computing facilities. This rapid evolution of computer systems has been accompanied by greatly expanded needs for computer-system management and administration. Currently these needs have begun to be addressed by highly capable automated management and administration tools and facilities. As with many other types of computational systems and facilities, from operating systems to applications, many different types of automated administration and management facilities have emerged, providing many different products with overlapping functionalities, but each also providing unique functionalities and capabilities, including a family of automated-application-release-management subsystems described in the current document.

During the past decade, tools for facilitating code instrumentation and related tasks have been developed under the category of aspect-oriented programming (“AOP”) tools and facilities. AOP provides tools for implementing crosscutting functionalities, such as instrumentation of code for analytics and logging error, within the object-oriented-programming paradigm and other such development strategies. Crosscutting functionalities are functionalities that cut across the various code-development strategies and paradigms, such as object-oriented programming and earlier top-down programming that seek to logically organize code into functionality-related compartments and hierarchies. Pipelines executed by automated-application-release-management subsystems often include functionality that cuts across the largely sequential stage and task pipeline organization. However, standard AOP are inapplicable to addressing problems associated with crosscutting functionalities at the pipeline level. The current document is particularly directed to implementations in which the automated-application-release-management subsystem is highly modularized to provide plug-in compatibility with a large variety of external third-party subsystems, libraries, and functionalities. This highly plug-in-compatible architecture provides for decreasing dependencies on various subsystems and components of a workflow-based cloud-management system in which the plug-compatible automated application-release-management subsystem is incorporated. Designers, developers, manufacturers and vendors, and, ultimately, users of a wide variety of different types of automated-application-release-management subsystems may realize benefits by addressing crosscutting functionalities at the pipeline level.

### SUMMARY

The current document is directed to automated-application-release-management facilities that support aspect-oriented-programming-like insertion of plug-in-implemented advice into release pipelines. In a described implementation, advice is represented by entries in an advice set or aggregation. These entries encode rules, advice types, and references to advice-implementing plug-ins. During release-pipeline execution, calls to the advice-implementing plug-ins are inserted prior to and after tasks in workflows corresponding to the tasks that are then executed by a workflow-execution engine. Rules may include release-pipeline parameters and advice definitions may use wildcard characters and other elements of regular expression in pipeline, stage, and task names.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and thru includes a cloud-connector server and cloud-connector nodes that cooperate to provide services that are distributed across multiple clouds.

FIG. 11 shows a workflow-based-cloud-management facility that has been developed to provide a powerful administrative and development interface to multiple multi-tenant cloud-computing facilities.

FIG. 12 provides an architectural diagram of the workflow-execution engine and development environment.

FIGS. 13A-C illustrate the structure of a workflow.

FIGS. 14A-B include a table of different types of elements that may be included in a workflow.

FIGS. 15A-B show an example workflow.

FIGS. 16A-C illustrate an example implementation and configuration of virtual appliances within a cloud-computing facility that implement the workflow-based management and administration facilities of the above-described WFMAD.

FIGS. 16D-F illustrate the logical organization of users and user roles with respect to the infrastructure-management-and-administration facility of WFMAD.

FIG. 17 illustrates the logical components of the infrastructure-management-and-administration facility of the WFMAD.

FIGS. 18-20B provide a high-level illustration of the architecture and operation of the automated-application-release-management facility of the WFMAD.

FIG. 21 shows a representation of a common protocol stack.

FIG. 22 illustrates the role of resources in RESTful APIs.

FIGS. 23A-D illustrate four basic verbs, or operations, provided by the HTTP application-layer protocol used in RESTful applications.

FIG. 24 illustrates additional details with respect to a particular type of automated-application-release-management-pipeline stage that is used in pipelines executed by a particular class of implementations of the automated application-release-management subsystem.

FIGS. 25A-B illustrate a highly modularized automated-application-release-management subsystem.

FIGS. 26A-E illustrate task execution controlled by an automated-application-release-management controller, subsequently referred to as a “management controller” in this document.

FIGS. 27A-F illustrate parameter passing between tasks provided by management controller.

FIGS. 28A-D provide extracts of control-flow diagrams to indicate how, in one implementation the management controller provides for inter-task information exchange.

FIG. 29 illustrates a symbolically encoded computer program and a corresponding physical, in-memory implementation of the computer program.

FIG. 30 illustrates the aspect-oriented-programming (“AOP”) approach to implementing crosscutting functionality.

FIG. 31 illustrates a method by which AOP-defined instrumentation is included during program execution.

FIGS. 32A-B illustrate the final interpretation or compilation of program byte code and aspect byte code by a virtual machine in a weaving process

FIGS. 33A-D illustrate one implementation of advice mechanisms for release pipelines in a family of automated-application-release-management subsystems that support incorporation of advice-based crosscutting functionality into release pipelines.

FIGS. 34A-34B provide control-flow diagrams that illustrate incorporation of advice logic into a release pipeline within an automated-application-release-management subsystem.

### DETAILED DESCRIPTION

It should be noted at the onset that the current document is directed to implemented functionalities, and systems containing implemented functionality, that are real, tangible, physical subcomponents of physical devices and systems. One frequently encounters statements made by those unfamiliar with modern science and technology with regard to the “abstract” nature of “software,” whatever the non-technically and non-scientifically educated individuals mean by these terms. Those familiar with science and technology well understand that much of the control logic incorporated within modern devices, machines, and systems is implemented as large sets of processor instructions that are physically stored in memories, mass-storage devices, and removable storage media and that must necessarily be so physically embodied in order to be accessed by processors and other computer machinery for execution. Physically embodied processor instructions are no less physical, tangible and real than power supplies processors component housings, electronic memories, internal and external communications hardware, and other such components of modern devices, machines, and systems.

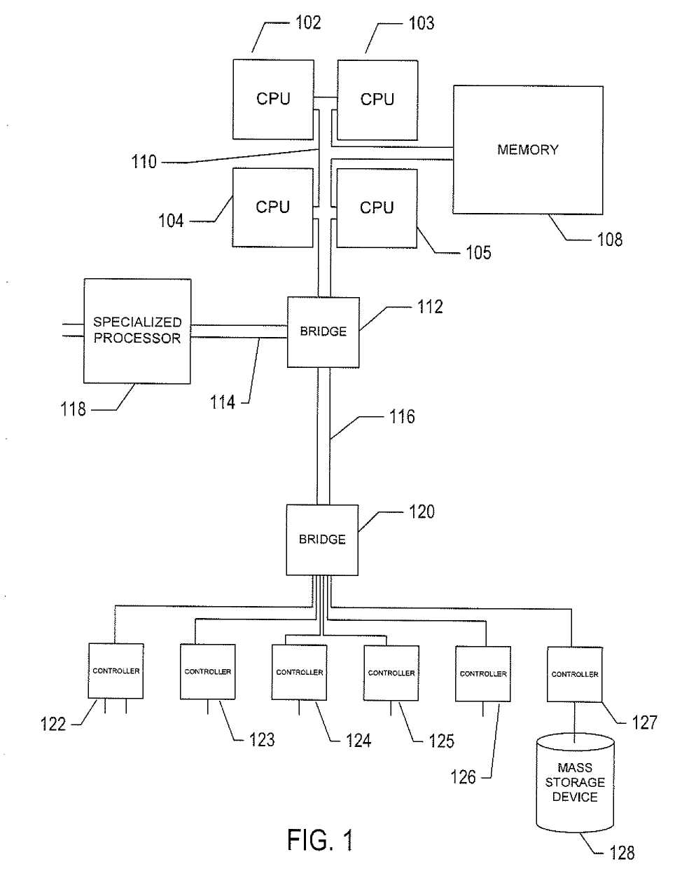

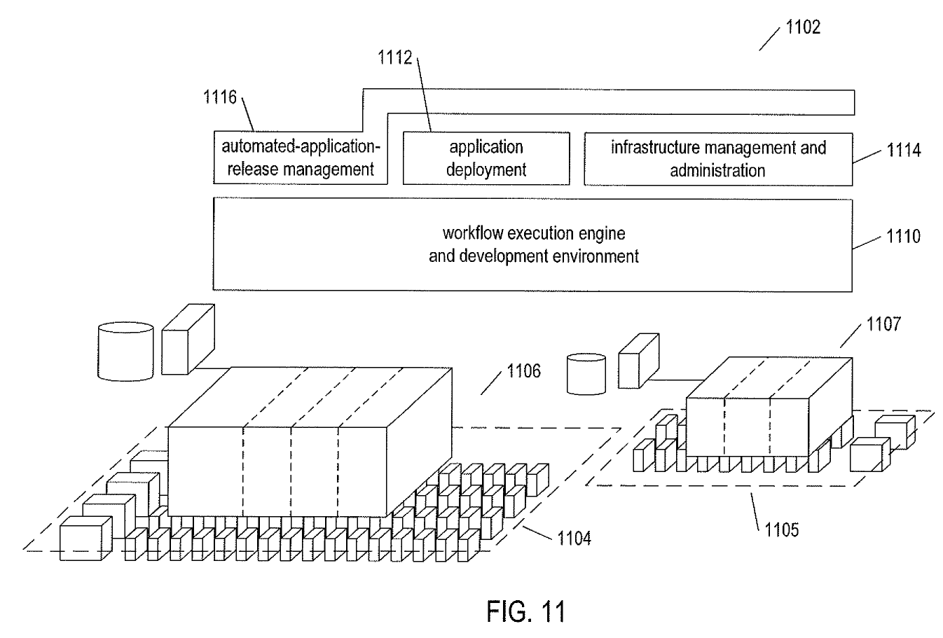

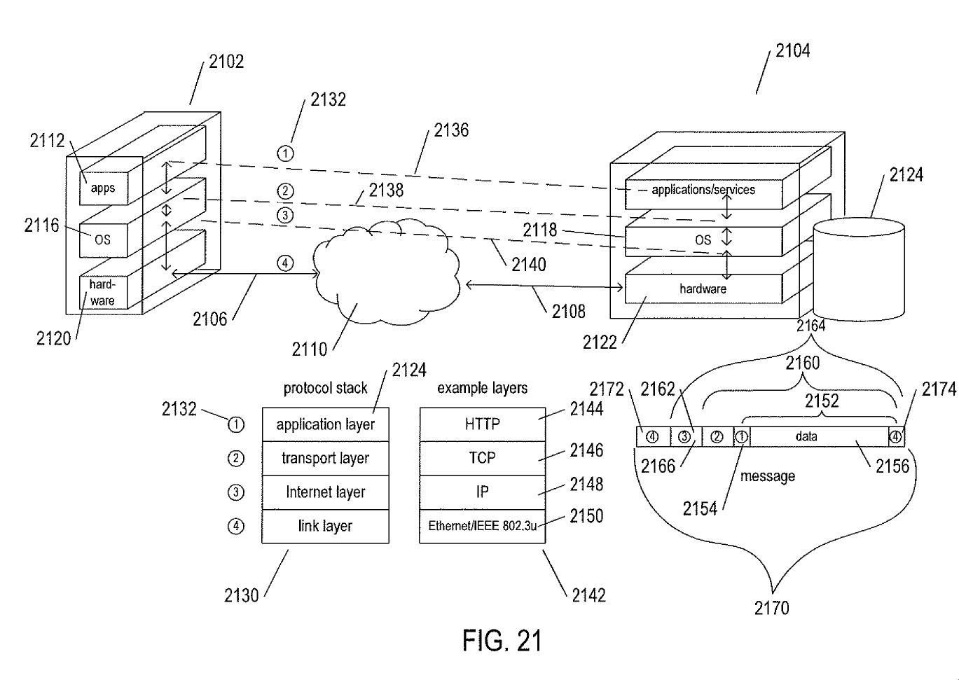

The current document is directed to a highly modularized automated application-release-management subsystem of a workflow-based cloud-management facility that supports advice-based introduction of cross-cutting functionalities into release pipelines. In a first subsection, below, a detailed description of computer hardware, complex computational systems, and virtualization is provided with reference to FIGS. 1-10. In a second subsection, an overview of a workflow-based cloud-management facility is provided with reference to FIGS. 11-20B. In a third subsection, the REST protocol and RESTFL communications are discussed with reference to FIGS. 21-23D. In a fourth subsection, a highly modularized automated application-release-management subsystem is discussed in a fifth subsection, run-time parameter-value exchanges between tasks of a release pipeline are discussed In a sixth subsection, aspect-oriented programming is discussed. In a seventh subsection, a highly modularized automated-application-release-management facility into which crosscutting functionality is introduced by advice-based mechanisms is disclosed.

### Computer Hardware Complex Computational Systems and Virtualization

The term “abstraction” is not, in any way, intended to mean or suggest an abstract idea or concept. Computational abstractions are tangible physical interfaces that ate implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms, “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software.” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPC memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end main frame computers, but may also include a plethora of various types of special-purpose computing devices, including data-storage systems, communications routers, network nodes, tablet computers, and mobile telephones.

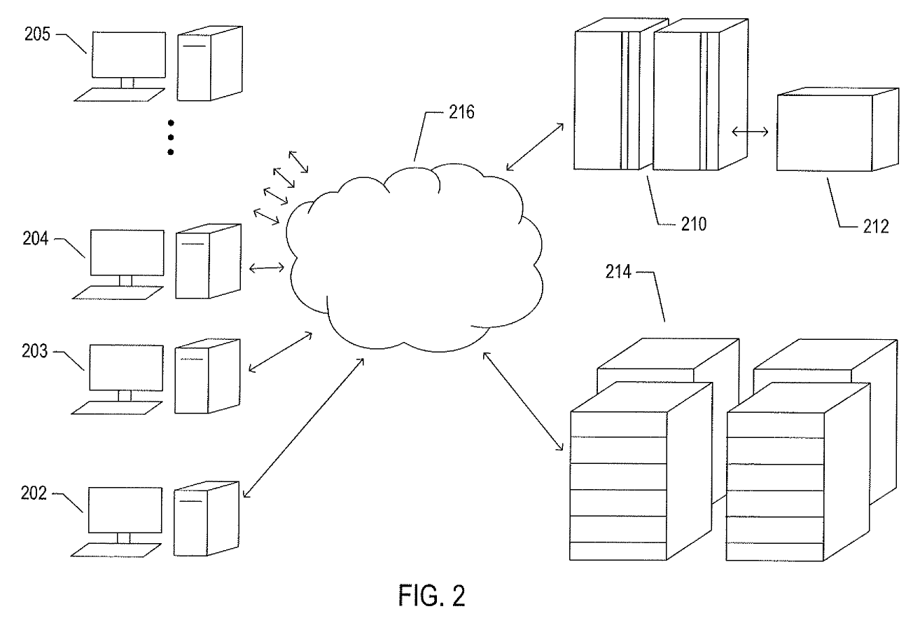

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems that diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders tracking completed orders, and other myriad different tasks associated with an e-commerce enterprise.

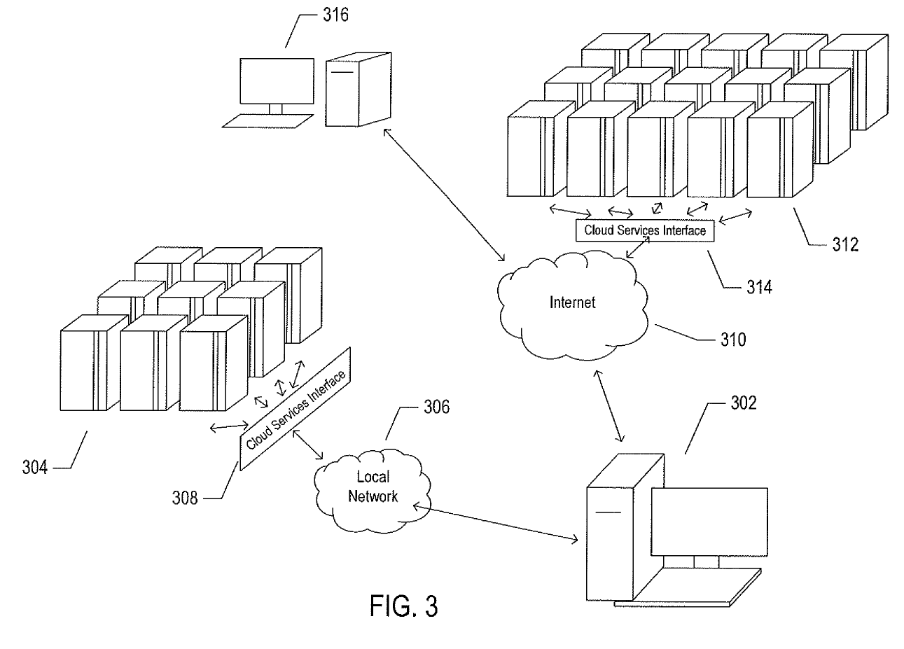

FIG. 3 illustrates cloud computing. In the recently developed cloud-computing paradigm, computing cycles and data-storage facilities are provided to organizations and individuals by cloud-computing providers. In addition larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud service inlet face 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

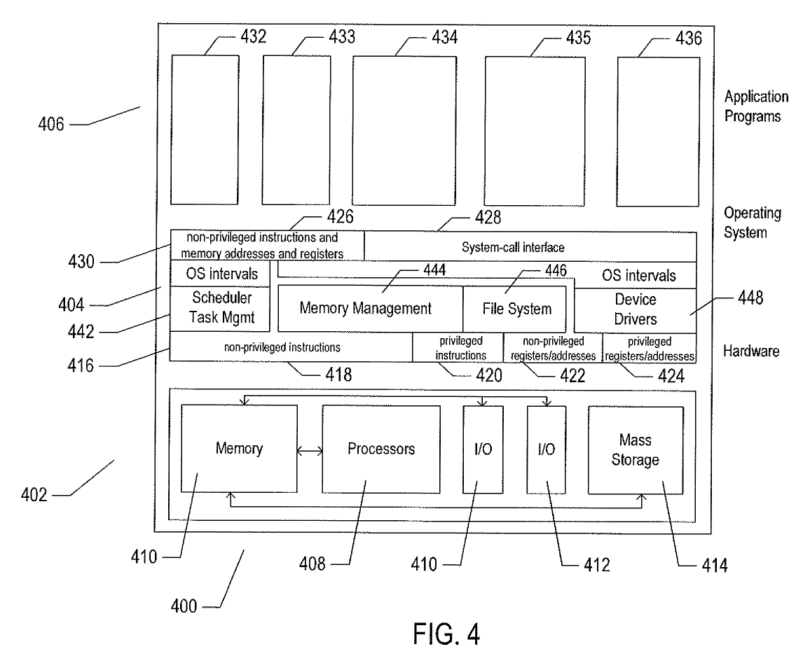

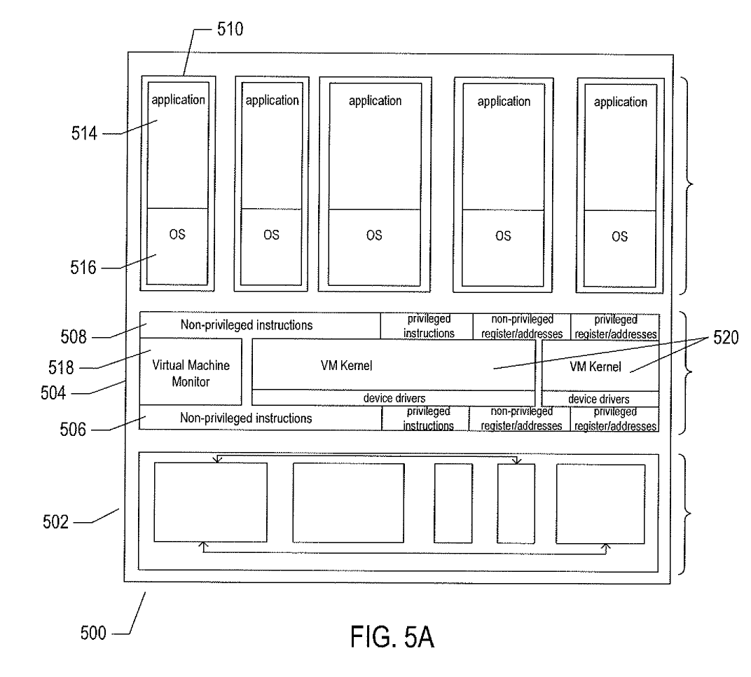

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422 and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

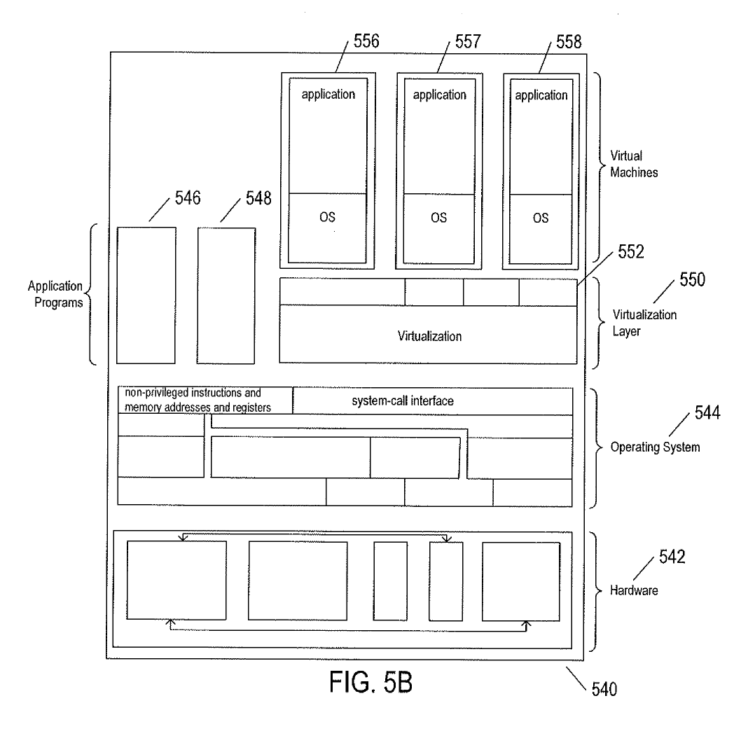

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes virtual-machine-monitor module 518 (“VMM”) that virtualizes physical processors in the hardware layer to create virtual processors on which each of the virtual machines executes. For execution efficiency, the virtualization layer attempts to allow virtually machines to directly execute non-privileged instruction and to directly access non-privileged registers and memory. However, when the guest operating system within a virtual machine accesses virtual privileged instructions, virtual privileged registers, and virtual privileged memory through the virtualization-layer interface the accesses result in execution of virtualization-layer code to simulate or emulate the privileged resources. The virtualization-layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 540 and 548 are shown running in the execution environment provided by the operating system. In addition, a virtualization layer 550 is also provided, in computer 540. but, unlike the virtualization layer 544 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers and guest operating systems are all physical entities that are implemented by computer instructions stored in physical data-storage devices, including electronic memories mass-storage devices, optical disks, magnetic disks, and other such devices The term “virtual” does not, in any way, imply that virtual hardware layers, virtualization layers, and guest operating systems are abstract or intangible. Virtual hardware layer, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors busses, and data-storage devices.

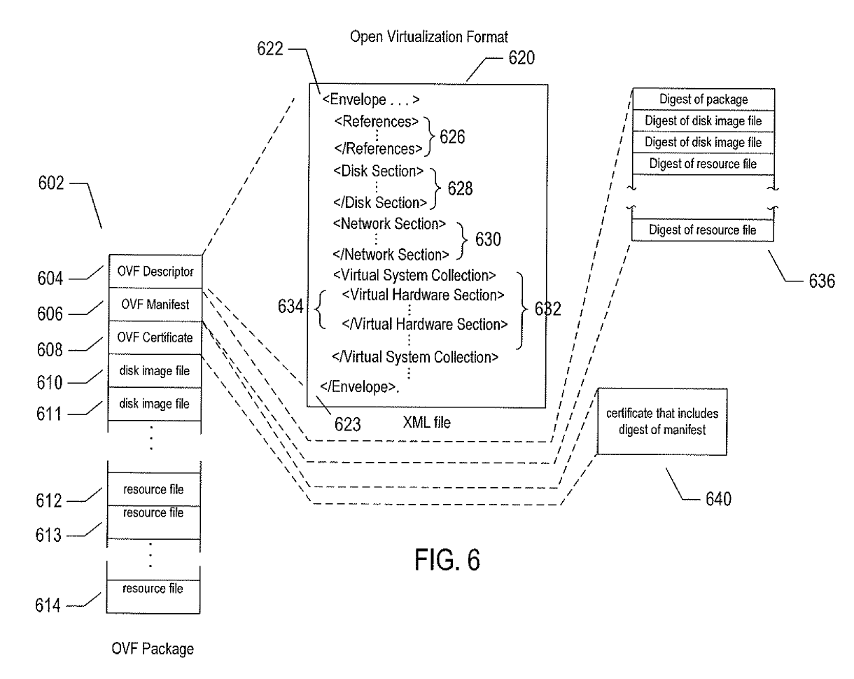

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608 one or more disk-image files 610-611, and one or more resource files 612-614. The OVF package can be encoded and stored as a single file or as a set of files. The OVF descriptor 604 is an XML document 620 that includes a hierarchical set of elements each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package and a collection of virtual-machine confirmations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

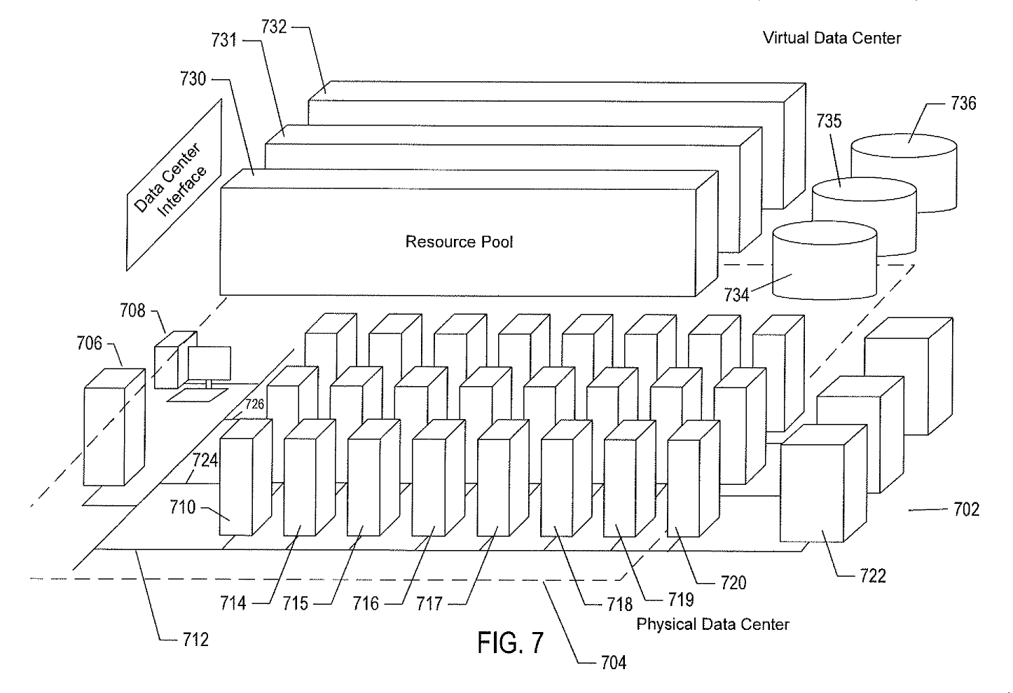

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs on which a virtual-data-center management interface may be displayed to system administrators and other users. The physical data center additionally includes generally large numbers of server computers, such as server computer if 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching and maintenance of virtual machines and virtual appliances as well as to provide high-level, distributed functionalities that involve pooling the resources of individual physical servers and migrating virtual machines among physical servers to achieve load balancing, fault tolerance, and high availability.

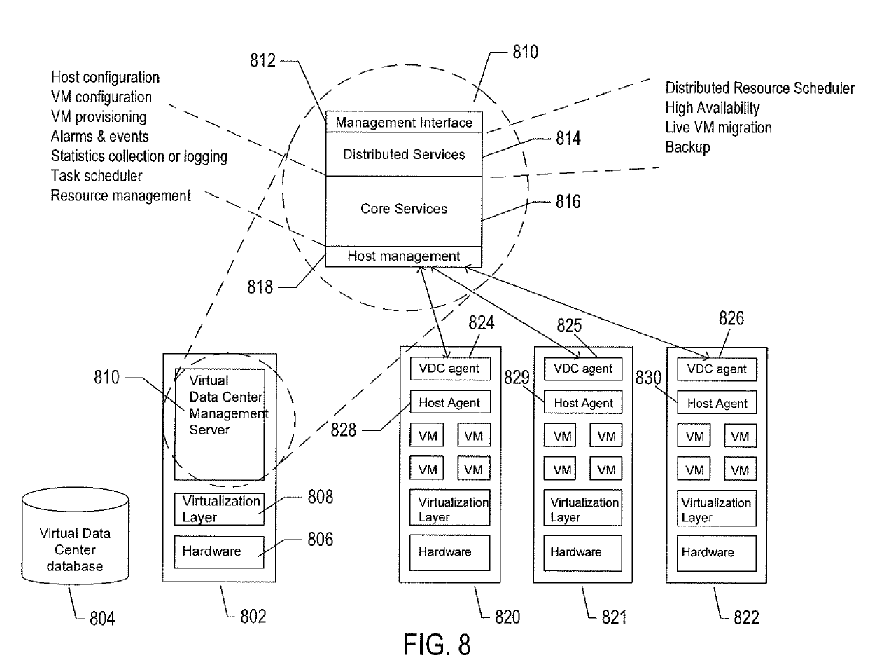

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808, and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that presides centralized virtual-machine backup and restore.

The core services provided by the VI-management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the visualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to a cloud-computing infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

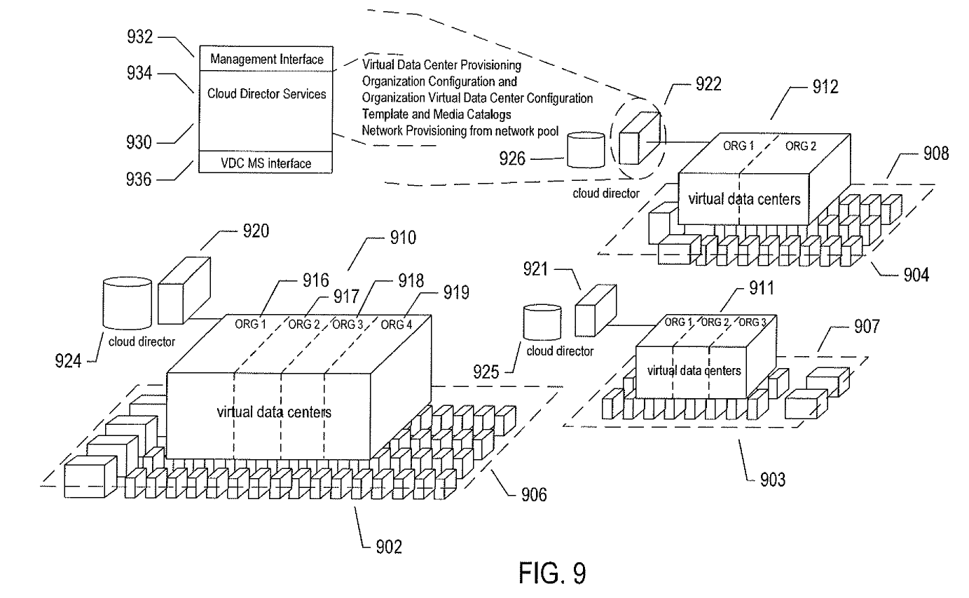

FIG. 9 illustrates a cloud-director level of abstraction. In FIG. 9, three different physical date centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-920. Each cloud-director server or servers runs a cloud-director virtual appliance 930 that includes a cloud-director management interface 932, a set of cloud-director services 934, and a virtual-data-center management-server interface. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

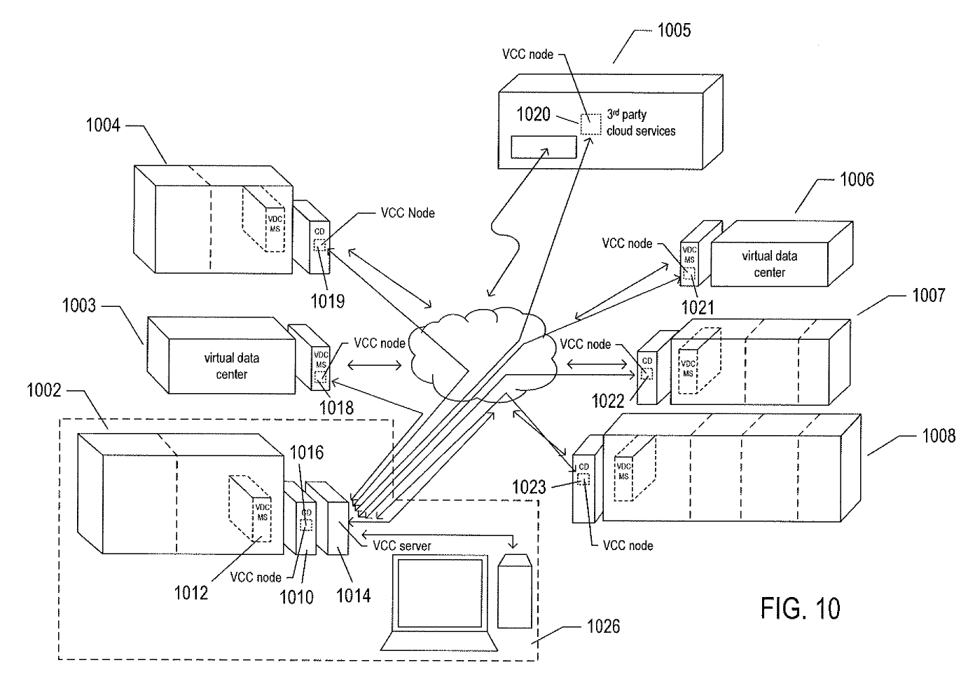

FIG. 10 illustrates virtual-cloud-connector nodes (“VCC nodes”) and a VCC server components of a distributed system that provides multi-cloud aggregation and that includes a cloud-connector server and cloud-connector nodes that cooperate to provide services that are distributed across multiple clouds VMware vCloud™ VCC servers and nodes are one example of VCC server and nodes in FIG. 10, seven different cloud-computing facilities are illustrated 1002-1008. Cloud-computing facility 1002 is a private multi-tenant cloud with a cloud director 1010 to that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC serves and VCC nodes are geographically and operationally distinct.

### Workflow-Based Cloud Management

FIG. 11 shows workflow-based cloud-management facility that has been developed to provide a powerful administrative and development interface to multiple multi-tenant cloud-computing facilities. The workflow-based management, administration, and development facility (“WFMAD”) is used to manage and administer cloud-computing aggregations, such as those discussed above with reference to FIG. 10, cloud-computing aggregations, such as those discussed above with reference to FIG. 9, and a variety of additional types of cloud-computing facilities as well as to deploy applications and continuously and automatically release complex applications on various types of cloud-computing aggregations. As shown in FIG. 11, the WFMAD 1102 is implemented above the physical hardware layers 1104 and 1105 and virtual data centers 1106 and 1107 of a cloud-computing facility or cloud-computing-facility aggregation. The WFMAD includes a workflow-execution engine and development environment 1110, an application-deployment facility 1112, an infrastructure-management-and-administration facility 1114, and an automated-application-release-management facility 1116. The workflow-execution engine and development environment 1110 provides an integrated development environment for constructing, validating, testing, and executing graphically expressed workflows, discussed in detail below. Workflows are high-level programs with many built-in functions, scripting tools, and development tools and graphical interfaces. Workflows provide an underlying foundation for the infrastructure-management-and-administration facility 1114, the application-development facility 1112, and the automated-application-release-management facility 1116. The infrastructure-management-and-administration facility 1114 provides a powerful and intuitive suite of management and administration tools that allow the resources of a cloud-computing facility or cloud-computing-facility aggregation to be distributed among clients and users of the cloud-computing facility or facilities and to be administered by a hierarchy of general and specific administrators. The infrastructure-management-and-administration facility 1114 provides interfaces that allow service architects to develop various types of services and resource descriptions that can be provided to users and clients of the cloud-computing facility or facilities, including many management and administrative services and functionalities implemented as workflows. The application-deployment facility 1112 provides an integrated application-deployment environment to facilitate building and launching complex cloud-resident applications on the cloud-computing facility or facilities. The application-deployment facility provides access to one or more artifact repositories that store and logically organize binary files and other artifacts used to build complex cloud-resident applications as well as access to automated tools used, along with workflows, to develop specific automated application-deployment tools for specific cloud-resident applications. The automated-application-release-management facility 1116 provides workflow-based automated release-management tools that enable cloud-resident-application developers to continuously generate application releases produced by automated deployment, testing, and validation functionalities. Thus, the WFMAD 1102 provides a powerful, programmable, and extensible management, administration, and development platform to allow cloud-computing facilities and cloud-computing-facility aggregations to be used and managed by organizations and teams of individuals.

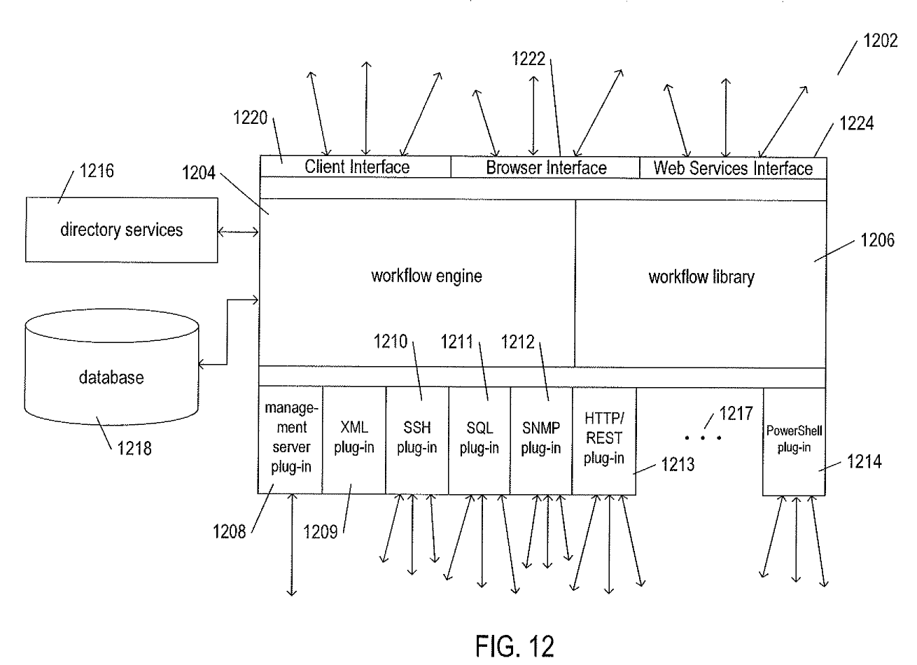

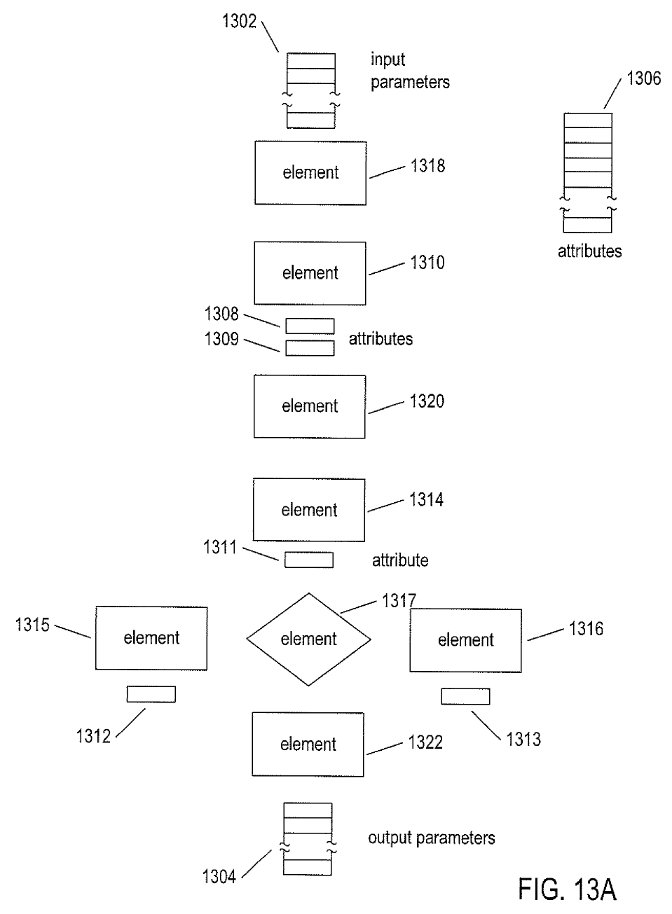

Next, the workflow-execution engine and development environment is discussed in greater detail. FIG. 12 provides an architectural diagram of the workflow-execution engine and development environment. The workflow-execution engine and development environment 1202 includes a workflow engine 1204, which executes workflows to carry out the many different administration, management, and development tasks encoded in workflows that comprise the functionalities of the WFMAD. The workflow engine, during execution of workflows accesses many built-in tools and functionalities provided by a workflow library 1206. In addition, both the routines and functionalities provided by the workflow library and the workflow engine access a wide variety of tools and computational facilities, provided by a wide variety of third-party providers, through a large set of plug-ins 1208-1214. Note that the ellipses 1216 indicate that many additional plug-ins provide, to the workflow engine and workflow-library routines, access to many additional third-party computational resources. Plug-in 1208 provides for access, by the workflow engine and workflow-library routines to a cloud-computing-facility or cloud-computing-facility-aggregation management server, such as a cloud director (920 in FIG. 9) or VCC server (1014 in FIG. 10). The XML plug-in 1209 provides access to a complete document object model (“DOM”) extensible markup language (“XML”) parser. The SSH plug-in 1210 provides access to an implementation of the Secure Shell v2 (“SSH-2”) protocol. The structured query language (“SQL”) plug-in 1211 provides access to a Java database connectivity (“JDBC”) API that, in turn, provides access to a wide range of different types of databases. The simple network management protocol (“SNMP”) plug-in 1212 provides access to an implementation of the SNMP protocol that allows the workflow-execution engine and development environment to connect to and receive information from, various SNMP-enabled systems find devices. The hypertext transfer protocol (“HTTP”)/representational state transfer (“REST”) plug-in 1213 provides access to REST web services and hosts. The PowerShell plug-in 1214 allows the workflow-execution engine and development environment to manage PowerShell hosts and run custom PowerShell operations. The workflow engine 1204 additionally accesses directory services 1216, such as a lightweight directory access protocol (“LDAP”) directory, that maintain distributed directory information and manages password-based user login. The workflow engine also accesses a dedicated database 1218 in which workflows and other information are stored. The workflow-execution engine and development environment can be accessed by clients running a client application that interfaces to a client interface 1220, by clients using web browsers that interface to a browser interface 1222, and by various applications and other executables running on remote computers that access the workflow-execution engine and development environment using a REST or small-object-access protocol (“SOAP”) via a web-service interface 1224. The client application that runs on a remote computer and interfaces to the client interface 1220 provides a powerful graphical user interface that allows a client to develop and store workflows for subsequent execution by the workflow engine. The user interface also allows clients to initiate workflow execution and provides a variety of tools for validating and debugging workflows. Workflow execution can be initiated via the browser interface 1222 and web-services interface 1224. The various interfaces also provide for exchange of data output by workflows and input of parameters and data to workflows.

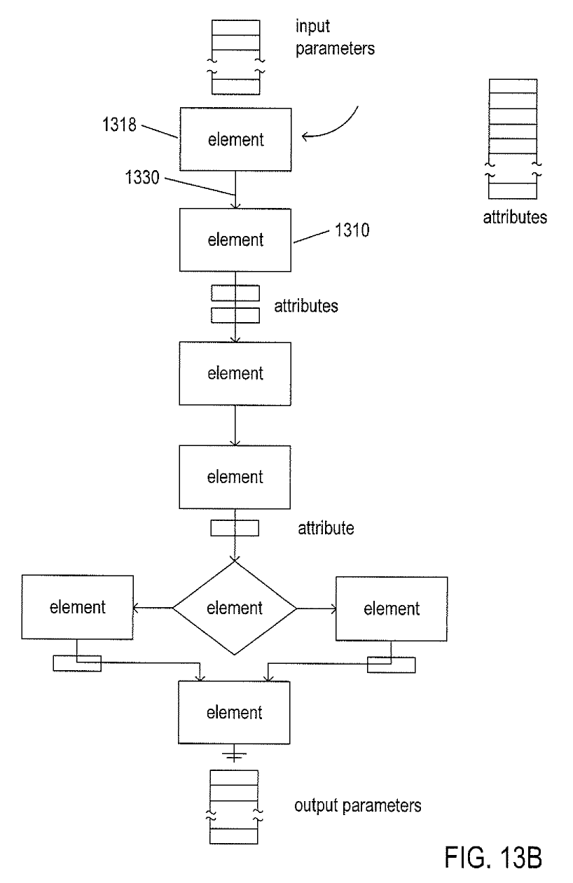

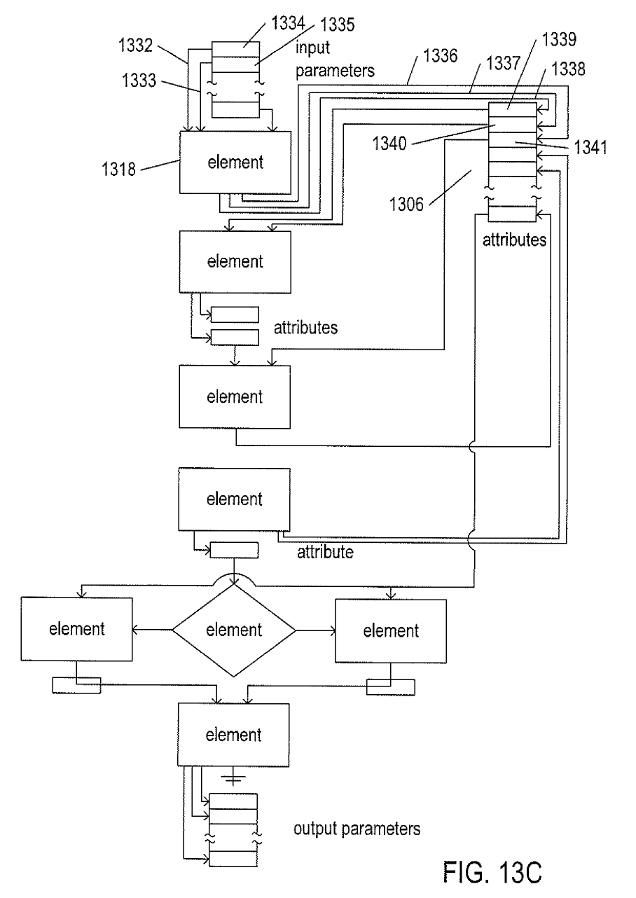

FIGS. 13A-C illustrate the structure of a workflow. A workflow is a graphically represented high-level program. FIG. 13A shows the main logical components of a workflow. These components include a set of one or more input parameters 1302 and a set of one or more output parameters 1304. In certain cases, a workflow may not include input and/or output parameters, but, in general, both input parameters and output parameters are defined for each workflow. The input and output parameters can have various different data types, with the values for a parameter depending on the data type associated with the parameter. For example, a parameter may have a string data type, in which case the values for the parameter can include any alphanumeric string or Unicode string of up to a maximum length. A workflow also generally includes a set of parameters 1306 that store values manipulated during execution of the workflow. This set of parameters is similar to a set of global variables provided by many common programming languages. In addition, attributes can be defined within individual elements of a workflow, and can be used to pass values between elements. In FIG. 13A, for example, attributes 1308-1309 are defined within element 1310 and attributes 1311, 1312 and 1313 are defined within elements 1314, 1315, and 1316, respectively. Elements, such as elements 1318, 1310, 1320, 1314-1316, and 1322 in FIG. 13A, are the execution entities within a workflow. Elements are equivalent to one or a combination of common constructs in programming languages, including subroutines, control structures, error handlers, and facilities for launching asynchronous and synchronous procedures. Elements may correspond to script routines, for example, developed to carry out an almost limitless number of different computational tasks. Elements are discussed, in greater detail, below.

As shown in FIG. 13B, the logical control flow within a workflow is specified by links, such as link 1330 which indicates that element 1310 is executed following completion of execution of element 1318. In FIG. 13B, links between elements are represented as single-headed arrows. Thus, links provide the logical ordering that is provided, in a common programming language, by the sequential ordering of statements. Finally, as shown in FIG. 13C, bindings that bind input parameters, output parameters, and attributes to particular roles with respect to elements specify the logical data flow in a workflow. In FIG. 13C, single-headed arrows, such as single-headed arrow 1332, represent bindings between elements and parameters and attributes. For example, bindings 1332 and 1333 indicate that the values of the first input parameters 1334 and 1335 are input to element 1318. Thus, the first two input parameters 1334-1335 play similar roles as arguments to functions in a programming language. As another example, the bindings represented by arrows 1336-1338 indicate that element 1318 outputs values that are stored in the first three attributes 1339, 1340, and 1341 of the set of attributes 1306.

Thus, a workflow is a graphically specified program, with elements representing executable entities, links representing logical control flow, and bindings representing logical data flow. A workflow can be used to specific arbitrary and arbitrarily complex logic, in a similar fashion as the specification of logic by a compiled structured programming language, an interpreted language, or a script language.

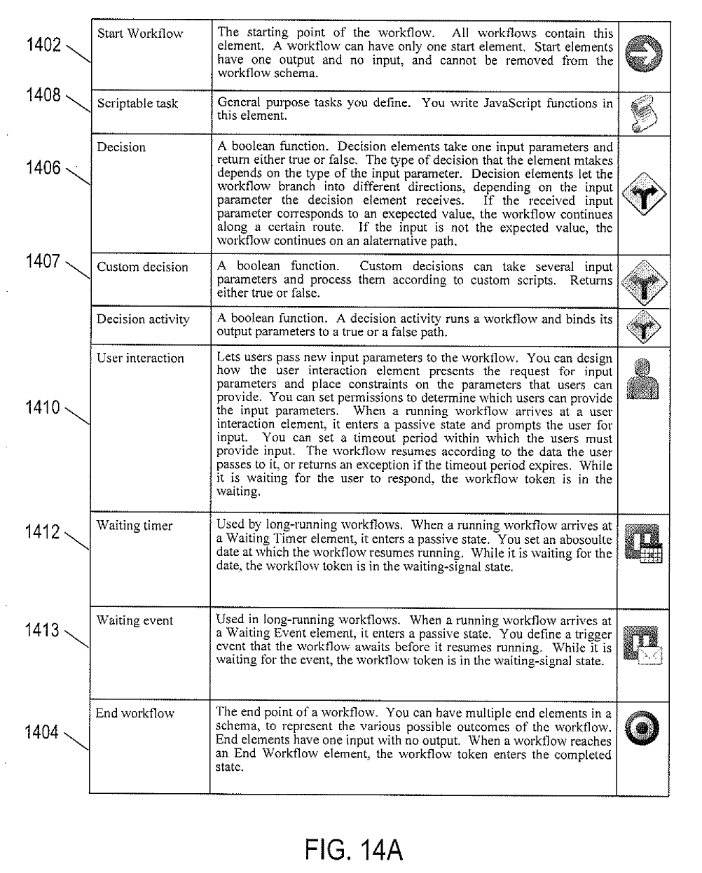

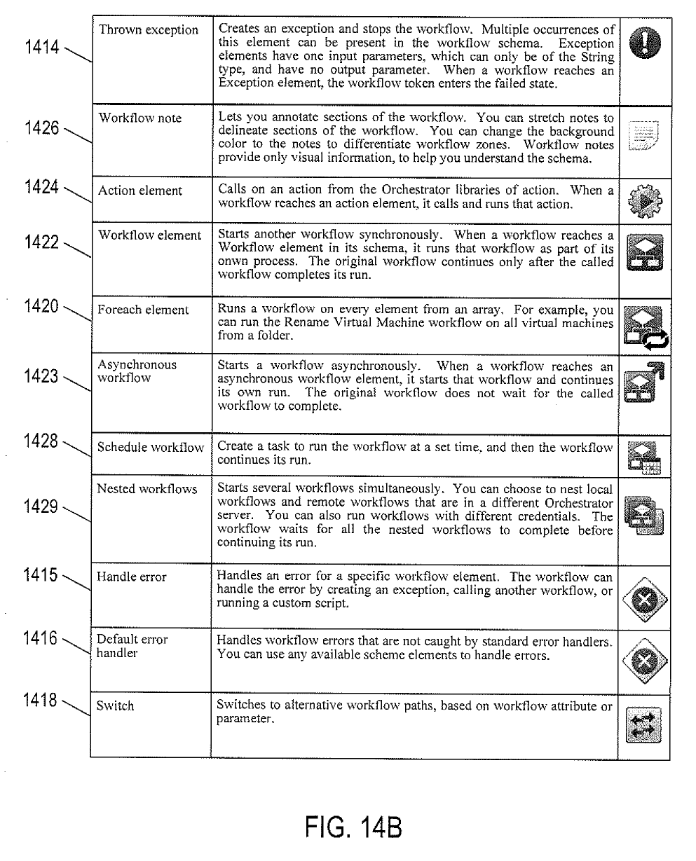

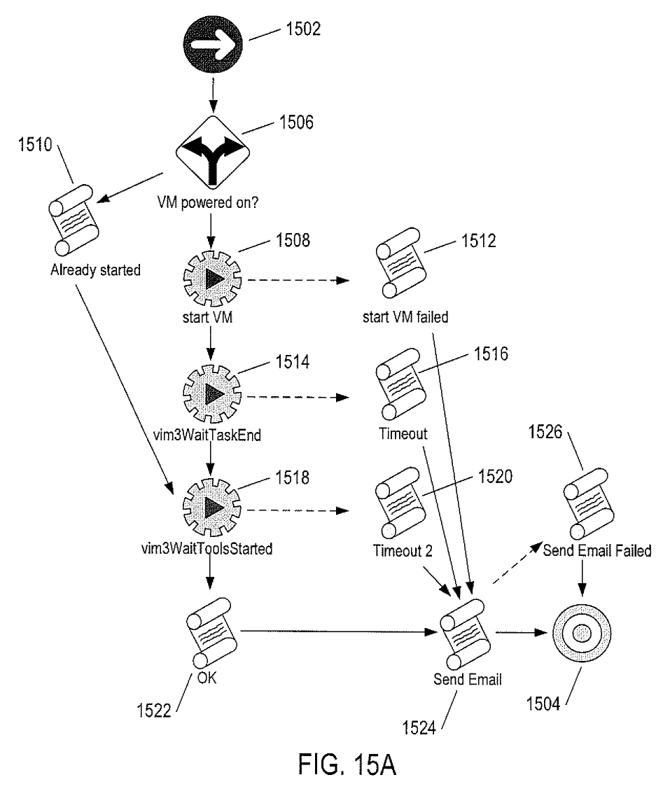

FIGS. 14A-B include a table of different types of elements that may be included in a workflow. Workflow elements may include a start-workflow element 1402 and an end-workflow element 1404, examples of which include elements 1318 and 1322, respectively, in FIG. 13 A. Decision workflow elements 1406-1407, an example of which is element 1317 in FIG. 13A, function as an if-then-else construct commonly provided by structured programming languages. Scriptable-task elements 1408 are essentially script routines included in a workflow. A user-interaction element 1410 solicits input from a user during workflow execution. Waiting-timer and waiting-event elements 1412-1413 suspend workflow execution for a specified period of time or until the occurrence of a specified event. Thrown-exception elements 1414 and error-handling elements 1415-1416 provide functionality commonly provided by throw-catch constructs in common programming languages. A switch element 1418 dispatches control to one of multiple paths, similar to switch statements in common programming languages, such as C and C++. A for each element 1420 is a type of iterator. External workflows can be invoked from a currently executing workflow by a workflow element 1422 or asynchronous-workflow element 1423. An action element 1424 corresponds to a call to a workflow-library routine. A workflow-note element 1426 represents a comment that can be included within a workflow. External workflows can also be invoked by schedule-workflow and nested-workflows elements 1428 and 1429.

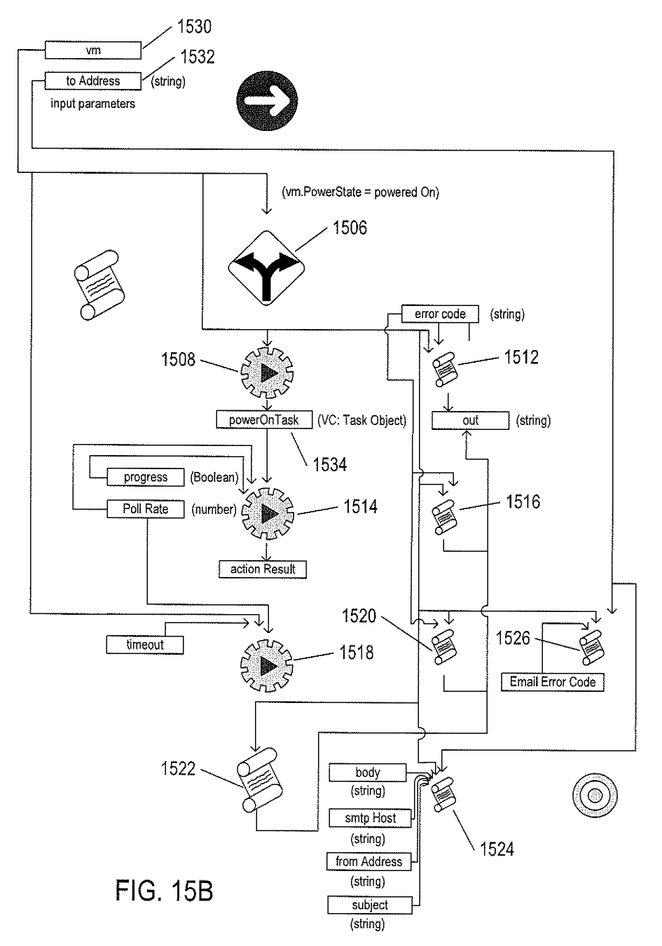

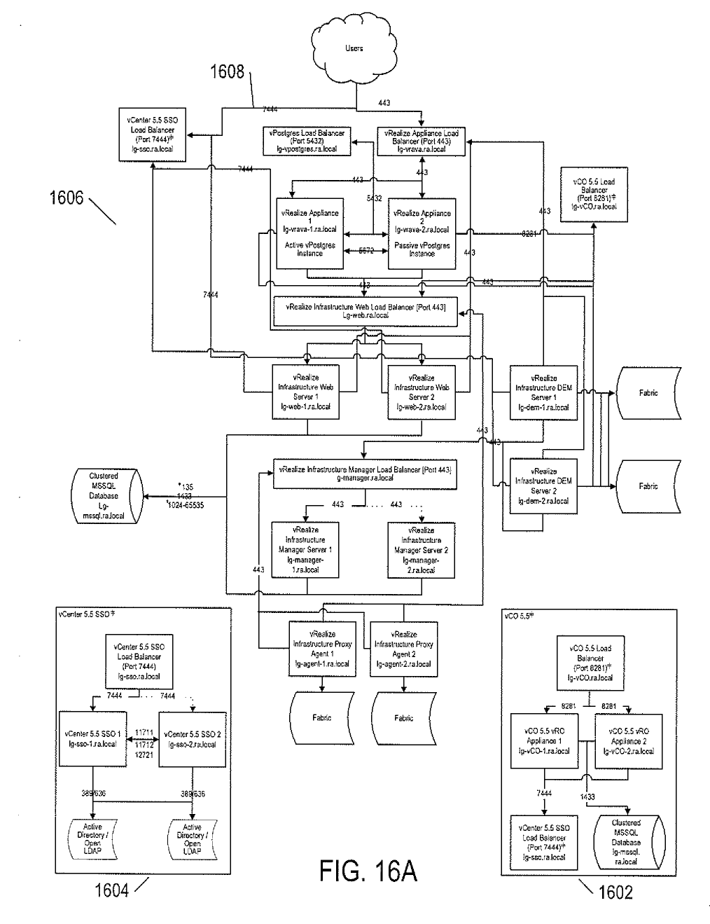

FIGS. 15A-B show an example workflow. The workflow shown in FIG. 15A is a virtual-machine-starting workflow that prompts a user to select a virtual machine to start and provides an email address to receive a notification of the outcome of workflow execution. The prompts are defined as input parameters. The workflow includes a start-workflow element 1502 and an end-workflow element 1504. The decision element 1506 checks to see whether or not the specified virtual machine is already powered on. When the VM is not already powered on, control flows to a start-VM action 1508 that calls a workflow-library function to launch the VM. Otherwise, the fact that the VM was already powered on is logged, in an already-started scripted element 1510. When the start operation fails, a start-VM-failed scripted element 1512 is executed as an exception handler and initializes an email message to report the failure. Otherwise, control flows to a vim3WaitTaskEnd action element 1514 that monitors the VM-starting task. A timeout exception handler is invoked when the start-VM task does not finish within a specified time period. Otherwise, control flows to a vim3WaitToolsStarted task 1518 which monitors starting of a tools application on the virtual machine. When the tools application fails to start, then a second timeout exception handler is invoked 1520. When all the tasks successfully complete, an OK scriptable task 1522 initializes an email body to report success. The email that includes either an error message or a success message is sent in the send-email scriptable task 1524. When sending the email fails, an email exception handles 1526 is called. The already-started, OK, and exception-handler scriptable elements 1510, 1512, 1516, 1520, 1522, and 1526 all log entries to a log file to indicate various conditions and errors. Thus, the workflow shown in FIG. 15A is a simple workflow that allows a user to specify a VM for launching to run an application.

FIG. 15B shows the parameter and attribute bindings for the workflow shown in FIG. 15A. The VM to start and the address to send the email are shown as input parameters 1530 and 1532. The VM to start is input to decision element 1506, start-VM action element 1508, the exception handlers 1512, 1516, 1520, and 1526, the send-email element 1524, the OK element 1522, and the vim3WaitToolsStarted element 1518. The email address furnished as input parameter 1532 is input to the email exception handler 1526 and the send-email element 1524. The VM-start task 1508 outputs an indication of the power on task initiated by the element in attribute 1534 which is input to the vim3WaitTaskEnd action element 1514. Other attribute bindings, input, and outputs are shown in FIG. 15B by additional arrows.

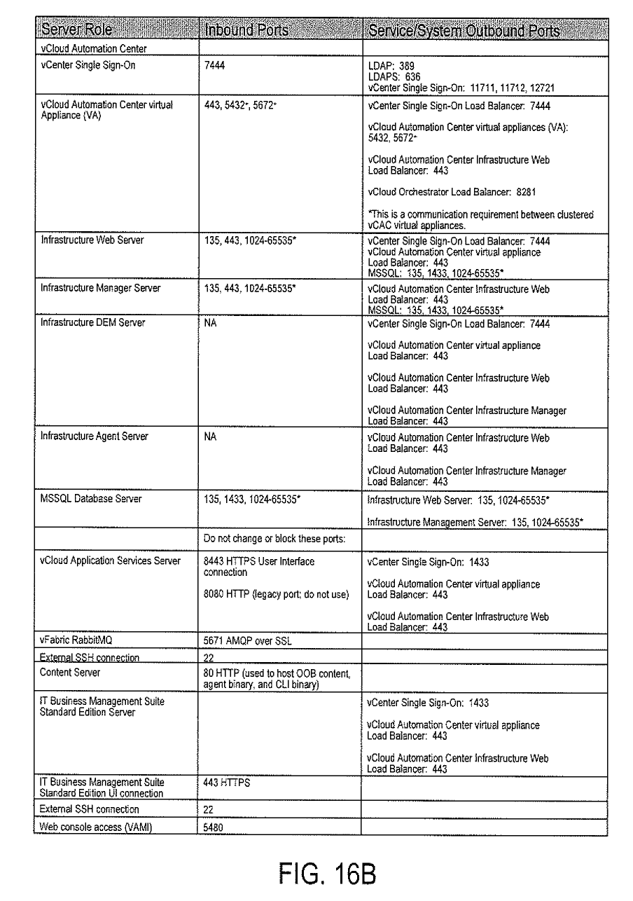

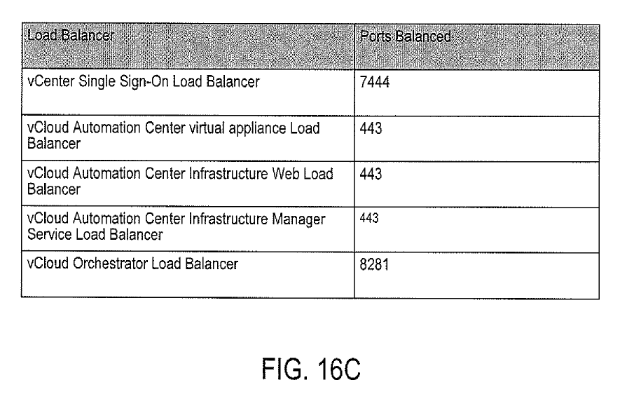

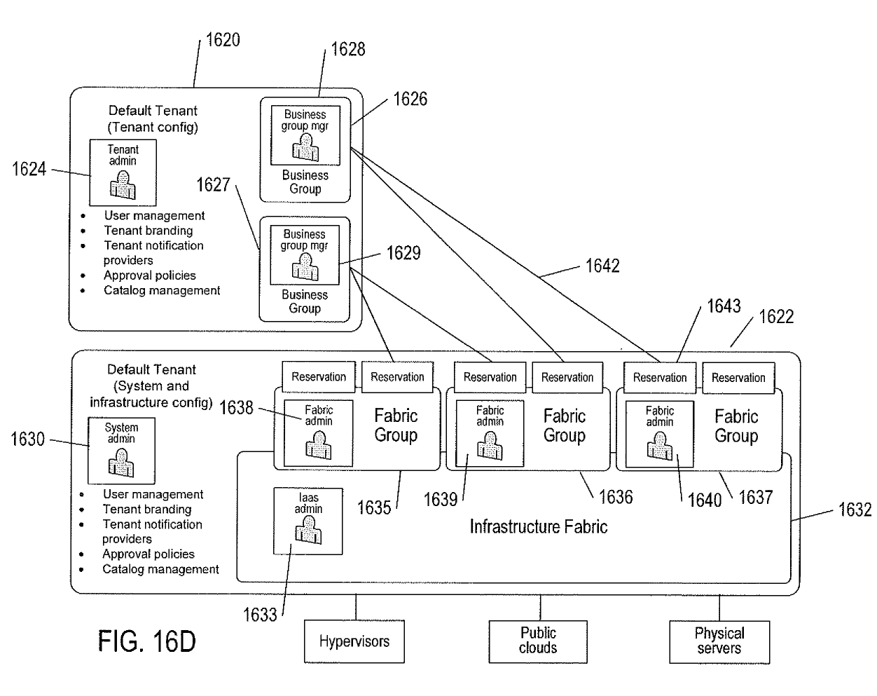

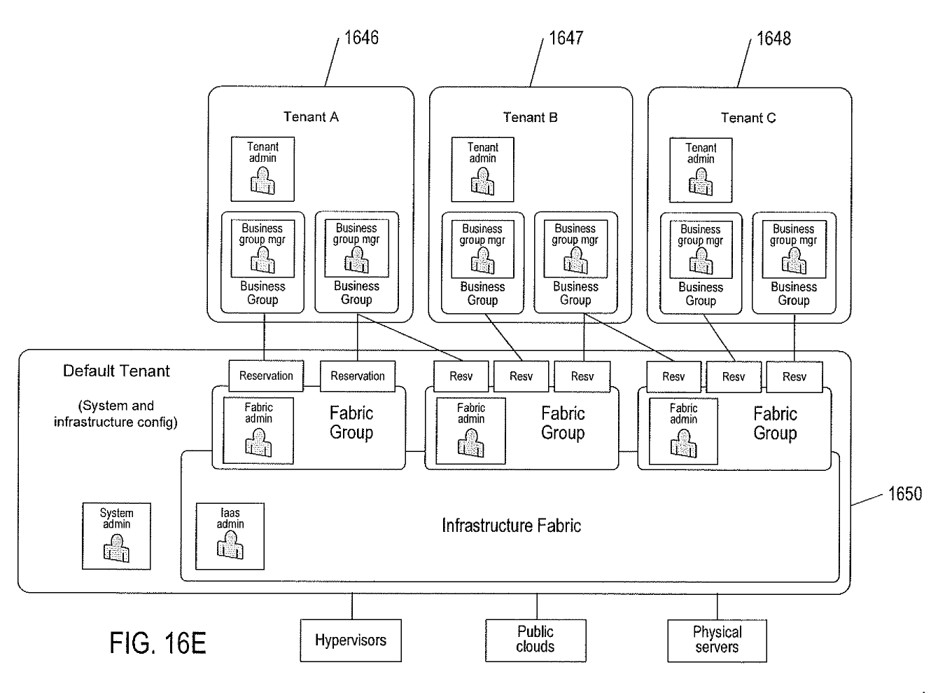

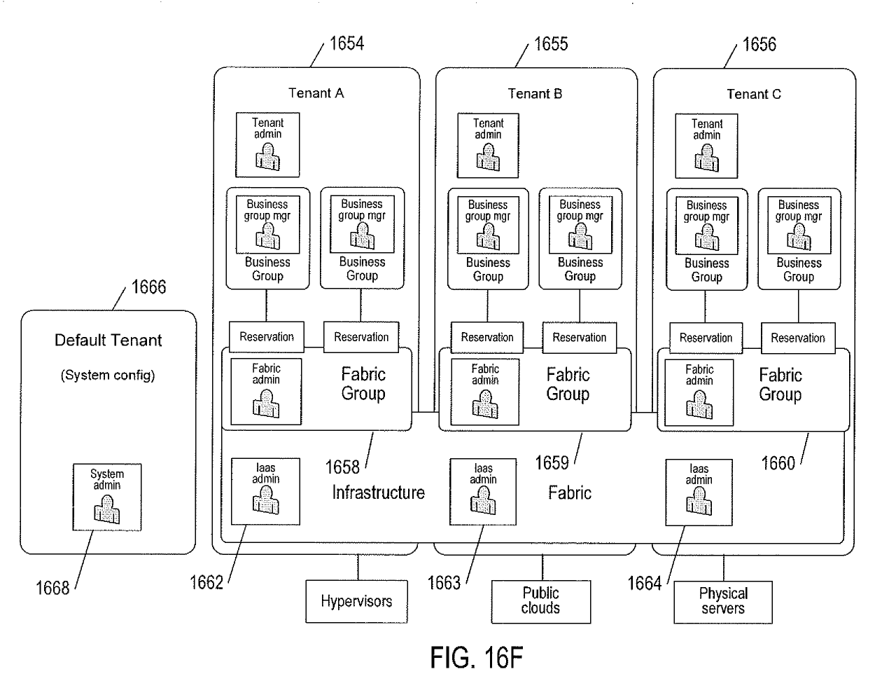

FIGS. 16A-C illustrate an example implementation and confirmation of virtual appliances within a cloud-computing facility that implement the workflow-based management and administration facilities of the above-described WFMAD. FIG. 16A shows a configuration that includes the workflow-execution engine and development environment 1602, a cloud-computing facility 1604, and the infrastructure-management-and-administration facility 1606 of the above-described WFMAD. Data and information exchanges between components are illustrated with arrows, such as arrow 1608, labeled with port numbers indicating inbound and outbound ports used for data and information exchanges. FIG. 16B provides a table of servers, the services provided by the server, and the inbound and outbound ports associated with the server. Table 16C indicates the ports balanced by various load balancers shown in the configuration illustrated in FIG. 16A. It can be easily ascertained from FIGS. 16A-C that the WFMAD is a complex, multi-virtual-appliance/virtual-server system that executes on many different physical devices of a physical cloud-computing facility.

FIGS. 16D-F illustrate the logical organization of users and user roles with respect to the infrastructure-management-and-administration facility of the WFMAD (1114 in FIG. 11). FIG. 16D shows a single-tenant configuration, FIG. 16E shows a multi-tenant configuration with a single default-tenant infrastructure configuration, and FIG. 16F shows a multi-tenant configuration with a multi-tenant infrastructure configuration. A tenant is an organizational unit, such as a business unit in an enterprise or company that subscribes to cloud services from a service provider. When the infrastructure-management-and-administration facility is initially deployed within a cloud-computing facility or cloud-computing-facility aggregation, a default tenant is initially configured by a system administrator. The system administrator designates a tenant administrator for the default tenant as well as an identity store, such as an active-directory server, to provide authentication for tenant users, including the tenant administrator. The tenant administrator can then designate additional identity stores and assign roles to users or groups of the tenant, including business groups, which are sets of users that correspond to a department or other organizational unit within the organization corresponding to the tenant. Business groups are, in turn, associated with a catalog of services and infrastructure resources. Users and groups of users can be assigned to business groups. The business groups, identity stores, and tenant administrator are all associated with a tenant configuration. A tenant is also associated with a system and infrastructure configuration. The system and infrastructure configuration includes a system administrator and an infrastructure fabric that represents the virtual and physical computational resources allocated to the tenant and available for provisioning to users. The infrastructure fabric can be partitioned into fabric groups, each managed by a fabric administrator. The infrastructure fabric is managed by an infrastructure-as-a-service (“IAAS”) administrator. Fabric-group computational resources can be allocated to business groups by using reservations.

FIG. 16D shows a single-tenant configuration for an infrastructure-management-and-administration facility deployment within a cloud-computing facility or cloud-computing-facility aggregation. The configuration includes a tenant configuration 1620 and a system and infrastructure configuration 1622. The tenant configuration 1620 includes a tenant administrator 1624 and several business groups 1626-1627, each associated with a business-group manager 1628-1629, respectively. The system and infrastructure configuration 1622 includes a system administrator 1630, an infrastructure fabric 1632 managed by an IAAS administrator 1633, and three fabric groups 1635-1637, each managed by a fabric administrator 1638-1640, respectively. The computational resources represented by the fabric groups are allocated to business groups by a reservation system, as indicated by the lines between business groups and reservation blocks, such as line 1642 between reservation block 1643 associated with fabric group 1637 and the business group 1626.

FIG. 16E shows a multi-tenant single-tenant-system-and-infrastructure-configuration deployment for an infrastructure-management-and-administration facility of the WFMAD. In this configuration there are three different tenant organizations, each associated with a tenant configuration 1646-1648. Thus, following configuration of a default tenant, a system administrator creates additional tenants for different organizations that together share the computational resources of a cloud-computing facility or cloud-computing-facility aggregation. In general, the computational resources are partitioned among the tenants so that the computational resources allocated to any particular tenant are segregated from and inaccessible to the other tenants in the configuration shown in FIG. 16E, these is a single default-tenant system and infrastructure configuration 1650, as in the previously discussed configuration shown in FIG. 16D.

FIG. 16F shows a multi-tenant configuration in which each tenant manages its own infrastructure fabric. As in the configuration shown in FIG. 16E, there are three different tenants 1654-1656 in the configuration shown in FIG. 16F. However, each tenant is associated with its own fabric group 1658-1660, respectively, and each tenant is also associated with an infrastructure-fabric IAAS administrator 1662-1664, respectively. A default-tenant system configuration 1666 is associated with a system administrator 1668 who administers the infrastructure fabric, as a whole.

System administrators, as mentioned above, generally install the WFMAD within a cloud-computing facility or cloud-computing-facility aggregation, create tenants, manage system-wide configuration, and are generally responsible for insuring availability of WFMAD services to users, in general. IAAS administrators create fabric groups, configure virtualization proxy agents, and manage cloud service accounts, physical machines, and storage devices. Fabric administrations manage physical machines and computational resources for their associated fabric groups as well as reservations and reservation policies through which the resources are allocated to business groups. Tenant administrators configure and manage tenants on behalf of organizations. They manage users and groups within the tenant organization, track resource usage, and may initiate reclamation of provisioned resources. Service architects create blueprints for items stored in user service catalogs which represent services and resources that can be provisioned to users. The infrastructure-management-and-administration facility defines many additional roles for various administrators and users to manage provision of services and resources to users of cloud-computing facilities and cloud-computing facility aggregations.

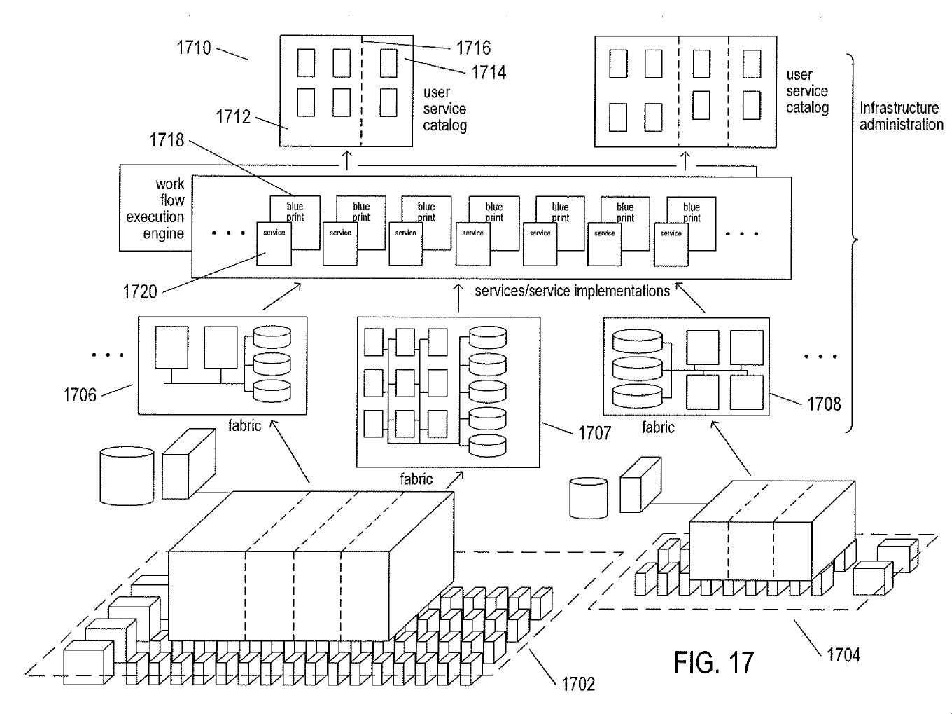

FIG. 17 illustrates the logical components of the infrastructure-management-and-administration facility (1114 in FIG. 11) of the WFMAD. As discussed above, the WFMAD is implemented within, and provides a management and development interface to, one or more cloud-computing facilities 1702 and 1704. The computational resources provided by the cloud-computing facilities, generally in the form of virtual servers, virtual storage devices, and virtual networks, are logically partitioned into fabrics 1706-1708. Computational resources are provisioned from fabrics to users. For example, a user may request one of more virtual machines running particular applications. The request is serviced by allocating the virtual machines from a particular fabric on behalf of the user. The services, including computational resources and workflow-implemented tasks, which a user may request provisioning of, are stored in a user service catalog, such as user service catalog 1710, that is associated with particular business groups and tenants. In FIG. 17, the items within a user service catalog are internally partitioned into categories, such as the two categories 1712 and 1714 and separated logically by vertical dashed line 1716. User access to catalog items is controlled by entitlements specific to business groups. Business group managers create entitlements that specify which users and groups within the business group can access particular catalog items. The catalog items are specified by service-architecture-developed blueprints such as blueprint 1718 for service 1720. The blueprint is a specification for a computational resource or task-service and the service itself is implemented by a workflow that is executed by the workflow-execution engine on behalf of a user.

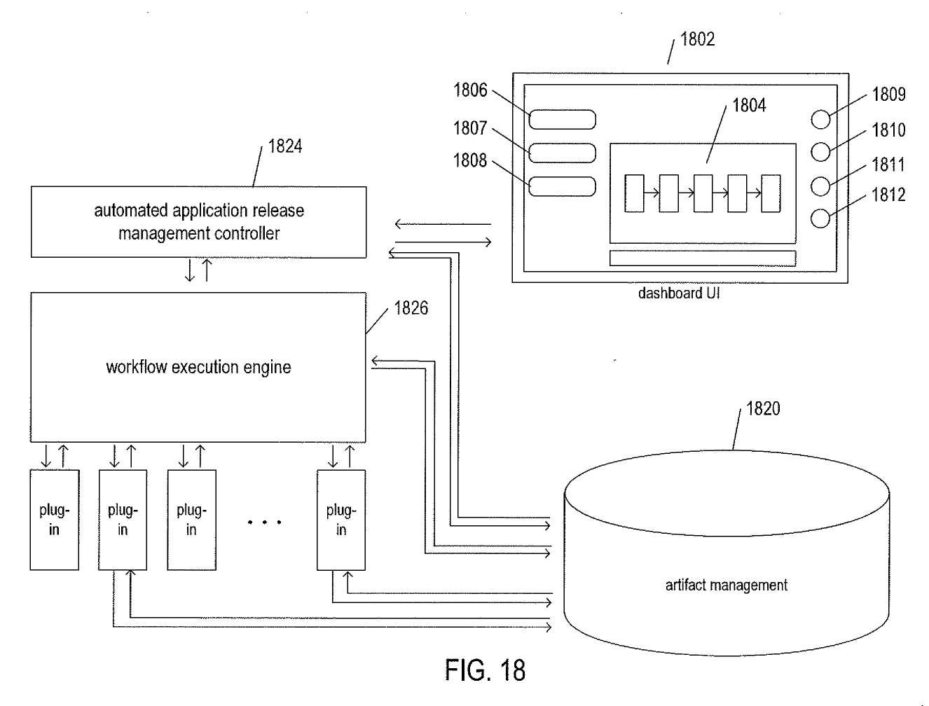

FIGS. 18-20B provide a high-level illustration of the architecture and operation of the automated-application-release-management facility (1116 in FIG. 11) of the WFMAD. The application-release management process involves storing logically organizing, and accessing a variety of different types of binary files and other files that represent executable programs and various types of data that are assembled into complete applications that are released to users for running on virtual servers within cloud-computing facilities. Previously, releases of new version of applications may have occurred over relatively long time intervals, such as biannually, yearly, or at even longer intervals. Minor versions were released at shorter intervals. However more recently, automated application-release management has provided for continuous release at relatively short intervals in order to provide new and improved functionality to clients as quickly and efficiently as possible.

FIG. 18 shows main components of the automated-application-release-management facility (1116 in FIG. 11). The automated-application-release-management component provides a dashboard user interface 1802 to allow release managers and administrators to launch release pipelines and monitor their progress. The dashboard may visually display a graphically represented pipeline 1804 and provide various input features 1806-1812 to allow a release manager or administrator to view particular details about an executing pipeline, create and edit pipelines, launch pipelines, and generally manage and monitor the entire application-release process. The various binary files and other types of information needed to build and test applications are stored in an artifact-management component 1820. An automated-application-release-management controller 1824 sequentially initiates execution of various workflows that together implement a release pipeline and serves as an intermediary between the dashboard user interface 1802 and the workflow-execution engine 1826.

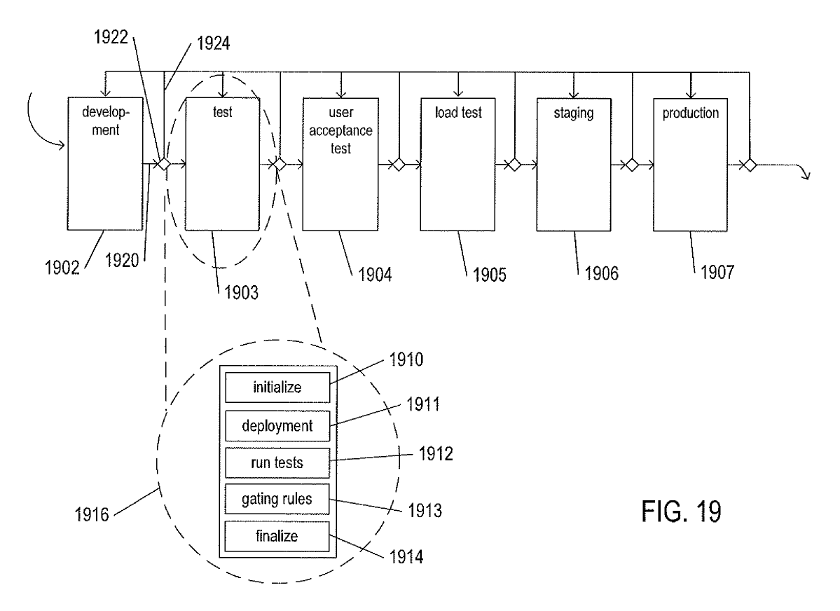

FIG. 19 illustrates a release pipeline. The release pipeline is a sequence of stages 1902-1907 that each comprises a number of sequentially executed tasks, such as the tasks 1910-1914 shown in inset 1916 that together compose stage 1903. In general, each stage is associated with gating rules that are executed to determine whether or not execution of the pipeline can advance to a next, successive stage. Thus, in FIG. 19, each stage is shown with an output arrow, such as output arrow 1920 that leads to a conditional step, such as conditional step 1922, representing the gating rules. When, as a result of execution of tasks within the stage, application of the gating rules to the results of the execution of the tasks indicates that execution should advance to a next stage, then any final tasks associated with the currently executing, stage are completed and pipeline execution advances to a next stage. Otherwise, as indicated by the vertical lines emanating from the conditional steps, such as vertical line 1924 emanating from conditional step 1922, pipeline execution may return to re-execute the current stage or a previous stage, often after developers have supplied corrected binaries, missing data, or taken other steps to allow pipeline execution to advance.

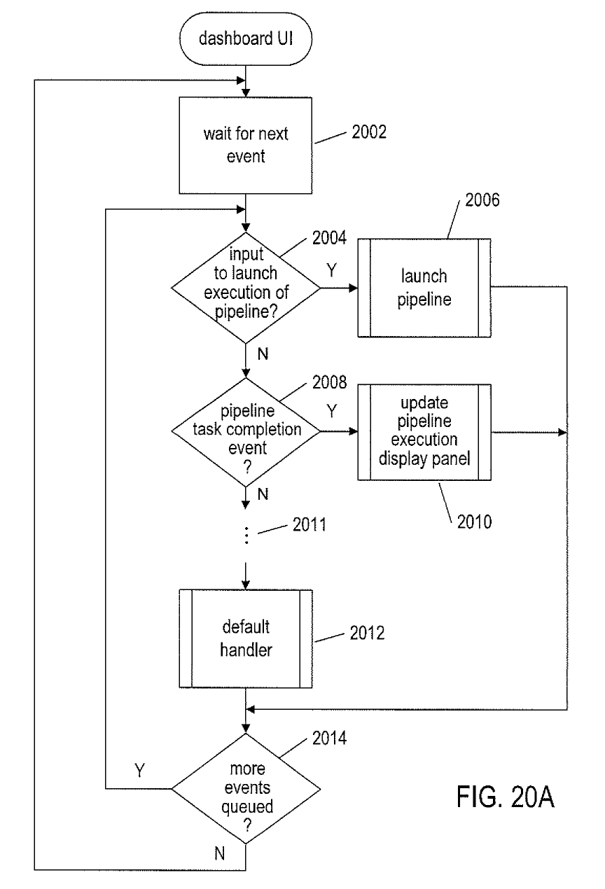

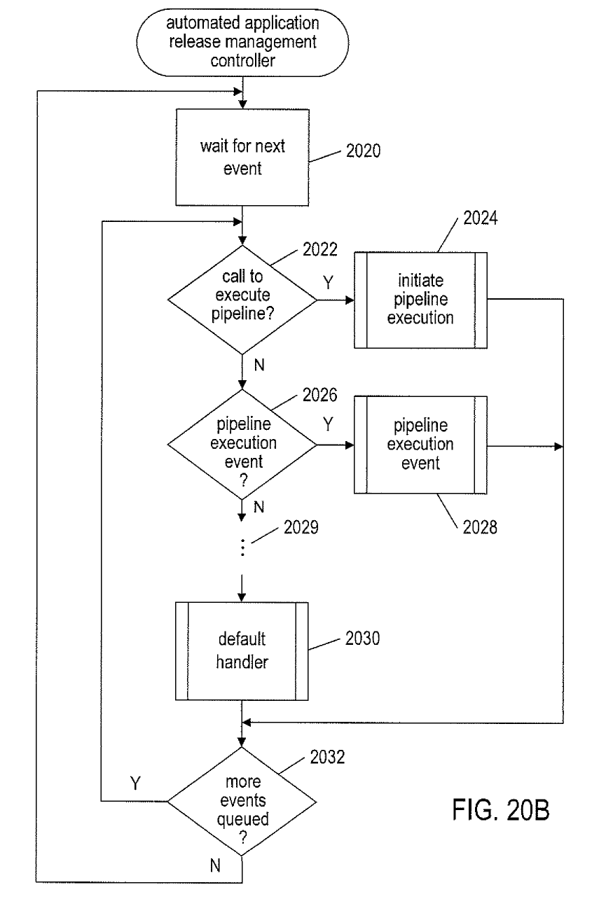

FIGS. 20A-B provide control-flow diagrams that indicate the general nature of dashboard and automated-application-release-management-controller operation. FIG. 20A shows a partial control-flow diagram for the dashboard user interface. In step 2002, the dashboard user interface waits for a next event to occur. When the next occurring event is input, by a release manager, to the dashboard to direct launching of an execution pipeline, as determined in step 2004, then the dashboard calls a launch-pipeline routine 2006 to interact with the automated-application-release-management controller to initiate pipeline execution. When the next-occurring event is reception of a pipeline task-completion event generated by the automated-application-release-management controller, as determined in step 2008, then the dashboard updates the pipeline-execution display panel within the user interface via a call to the routine “update pipeline execution display panel” in step 2010. There are many other events that the dashboard responds to, as represented by ellipses 2011. including many additional types of user input and many additional types of events generated by the automated-application-release-management controller that the dashboard responds to by altering the displayed user interface. A default handler 2012 handles rare or unexpected events. When there are more events queued for processing by the dashboard, as determined in step 2014, then control returns to step 2004. Otherwise, control returns to step 2002 where the dashboard waits for another event to occur.

FIG. 20B shows a partial control-flow diagram for the automated application-release-management controller. The control-flow diagram represents an event loop, similar to the event loop described above with reference to FIG. 20A. In step 2020, the automated application-release-management controller waits for a next event to occur. When the event is a call from the dashboard user interface to execute a pipeline, as determined in step 2022, then a routine is called, in step 2024, to initiate pipeline execution via the workflow-execution engine. When the next-occurring event is a pipeline-execution event generated by a workflow, as determined in step 2026, then a pipeline-execution-event routine is called in step 2028 to inform the dashboard of a status change in pipeline execution as well as to coordinate next steps for execution by the workflow-execution engine. Ellipses 2029 represent the many additional types of events that are handled by the event loop. A default handler 2030 handles rare and unexpected events. When there are more events queued for handling, as determined in step 2032, control returns to step 2022. Otherwise, control returns to step 2020 where the automated application-release-management controller waits for a next event to occur.

### The REST Protocol and RESTful Applications

Electronic communications between computer systems generally comprises packets of information, referred to as datagrams, transferred from client computers to serves computers and from server computers to client computers. In many cases, communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” FIG. 21 shows a representation of a common protocol stack. In FIG. 21, a representation of a common protocol stack 2130 is shown below the interconnected server and client computers 2104 and 2102. The layers are associated with layer numbers, such as layer number “1” 2132 associated with the application layer 2134. These same layer numbers are used in the depiction of the interconnection of the client computer 2102 with the server computer 2104, such as layer number “1” 2132 associated with a horizontal dashed line 2136 that represents interconnection of the application layer 2112 of the client computer with the applications services layer 2114 of the server computer through an application-layer protocol. A dashed line 2136 represents interconnection via the application-layer protocol in FIG. 21, because this interconnection is logical, rather than physical. Dashed-line 2138 represents the logical interconnection of the operating-system layers of the client and server computers via a transport layer. Dashed line 2140 represents the logical interconnection of the operating systems of the two computer systems via an Internet-layer protocol. Finally, links 2106 and 2108 and cloud 2110 together represent the physical communications media and components that physically transfer data from the client computer to the serves computer and from the server computer to the client computer. These physical communications components and media transfer data according to a link-layer protocol. In FIG. 21, a second table 2142 aligned with the table 2130 that illustrates the protocol stack includes example protocols that may be used for each of the different protocol layers. The hypertext transfer protocol (“HTTP”) may be used as the application-layer protocol 2144, the transmission control protocol (“TCP”) 2146 may be used as the transport-layer protocol, the Internet protocol 2148 (“IP”) may be used as the Internet-layer protocol, and, in the case of a computer system interconnected through a local Ethernet to the Internet, the Ethernet/IEEE 802.3u protocol 2150 may be used for transmitting and receiving information from the computer system to the complex communications components of the Internet. Within cloud 2110, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams such as datagram 2152. The datagram may generally include a header 2154 as well as the data 2156, encoded as a sequence of bytes within a block of memory. The header 2151 is generally a record composed of multiple byte-encoded fields. The call by the application program to an application-layer system call is represented in FIG. 21 by solid vertical arrow 2158. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 2160 includes a transport-layer-message header 2162 and an application-layer datagram 2152. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally, concerned with error control, segmentation, as discussed above, flow control congestion control, application addressing, and other aspects of reliable end-to-end message transfer. The transport-layer datagrams are then forwarded to the Internet layer via system calls within the operating system and are embedded within Internet-layer datagrams 2164, each including an Internet-layer header 2166 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a network-interface controller (“NIC”) which embeds the Internet-layer datagram 2164 into a link-layer datagram 2170 that includes a link-layer header 2172 and generally includes a number of additional bytes 2174 appended to the end of the Internet-layer datagram. The link-layer header includes collision-control and error-control information as well as local-network addresses. The link-layer packet or datagram 2170 is a sequence of bytes that includes information introduced by each of the layers of the protocol stack as well as the actual data that is transferred from the source computer to the destination computer according to the application-layer protocol.

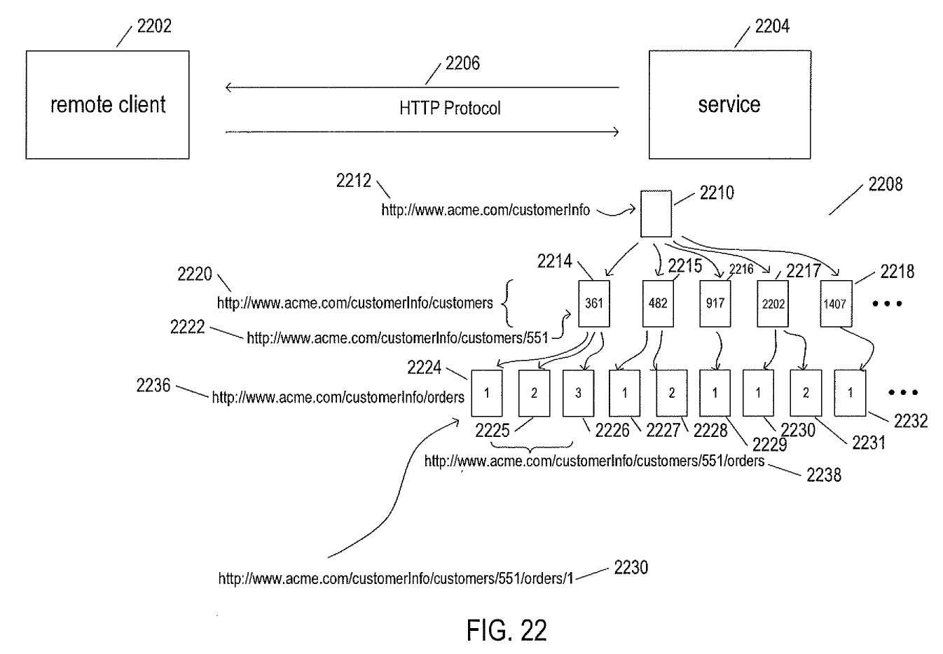

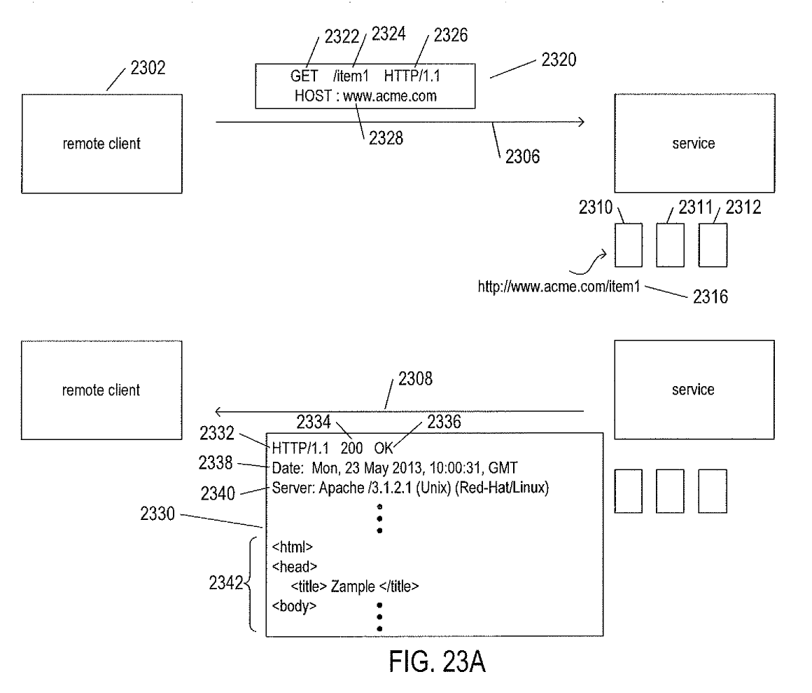

Next, the RESTful approach to web-service APIs is described, beginning with FIG. 22. FIG. 22 illustrates the role of resources in RESTful APIs. In FIG. 22, and in subsequent figures, a remote client 2262 is shown to be interconnected and communicating with a service provided by one or more service computers 2204 via the HTTP protocol 2206. Many RESTful APIs are based on the HTTP protocol. Thus, the focus is on the application layer in the following discussion. However as discussed above with reference to FIG. 22, the remote client 2202 and service provided by one or more server computers 2204 are, in fact, physical systems with application, operating-system and hardware layers that are interconnected with various types of communications media and communications subsystems, with the HTTP protocol the highest-level layer in a protocol stack implemented in the application, operating-system, and hardware layers of client computers and server computers. The service may be provided by one or more server computers, as discussed above in a preceding section. As one example, a number of servers may be hierarchically organized as various levels of intermediary servers and end-point servers. However, the entire collection of servers that together provide a service are addressed by a domain name included in a uniform resource identifier (“URI”), as further discussed below. A RESTful API is based on a small set of verbs, or operations, provided by the HTTP protocol and on resources, each uniquely identified by a corresponding URI. Resources are logical entities, information about which is stored on one or more servers that together comprise a domain. URIs are the unique names for resources. A resource about which information is stored on a server that is connected to the Internet has a unique URI that allows that information to be accessed by any client computer also connected to the Internet with proper authorization and privileges. URIs are thus globally unique identifiers, and can be used to specify resources on server computers throughout the world. A resource may be any logical entity, including people digitally encoded documents, organizations, and other such entities that can be described and characterized by digitally encoded information. A resource is thus a logical entity. Digitally encoded information that describes the resource and that can be accessed by a client computer from a server computer is referred to as a “representation” of the corresponding resource. As one example, when a resource is a web page, the representation of the resource may be a hypertext markup language (“HTML”) encoding of the resource. As another example, when the resource is an employee of a company, the representation of the resource may be one or more records, each containing one or more fields, that store information characterizing the employee, such as the employee's name, address, phone number, job title, employment history, and other such information.

In the example shown in FIG. 22, the web servers 2204 provides a RESTful API based on the HTTP protocol 2206 and a hierarchically organized set of resources 2208 that allow clients of the service to access information about the customers and orders placed by customers of the Acme Company. This service may be provided by the Acme Company itself or by a third-party information provider. All of the customer and order information is collectively represented by a customer information resource 2210 associated with the URI “http:www.acme.com/customerInfo” 2212. As discussed further below, this single URI and the HTTP protocol together provide sufficient information for a remote client computer to access any of the particular types of customer and order information stored and distributed by the service 2204. A customer information resource 2210 represents a large number of subordinate resources. These subordinate resources include, for each of the customers of the Acme Company, a customer resource, such as customer resource 2214. All of the customer resources 2214-2218 are collectively named or specified by the single URL “http://www.acme.com/customerInfo/customers” 2220. Individual customer resources, such as customer resource 2214, are associated with customer-identifier numbers and are each separately addressable by customer-resource-specific URIs, such as URI “http://www.acme.com/customerInfo/customers/361” 2222 which includes the customer identifier “361” for the customer represented by customer resource 2214. Each customer may be logically associated with one or more orders. For example, the customer represented by customer resource 2214 is associated with three different orders 2224-2220, each represented by an order resource. All of the orders are collectively specified or named by a single URI “http://www.acme.com/customerInfo/orders” 2236. All of the orders associated with the customer represented by resource 2214, orders represented by order resources 2224-2226, can be collectively specified by the URI “http://www.acme.com/customerInfo/customer/361/orders” 2238. A particular order, such as the order represented by order resource 2224, may be specified by a unique URI associated with that order, such as URI “http://www.acme.com/customerInfo/customer/361/orders/1” 2240, where the final “1” is an order number that specifies a particular order within the set of orders corresponding to the particular customer identified by the customer identifier “361.”

In one sense, the URIs bear similarity to path names to files file directories provided by computer operating systems. However, it should be appreciated that resources, unlike files, are logical entities rather than physical entities, such as the set of stored bytes that together compose a file within a computer system. When a file is accessed through a path name, a copy of a sequence of bytes that are stored in a memory or mass-storage device as a portion of that file are transferred to an accessing entity. By contrast, when a resource is accessed through a URI, a server computer returns a digitally encoded representation of the resource, rather than a copy of the resource. For example, when the resource is a human being, the service accessed via a URI specifying the human being may return alphanumeric encodings of various characteristics of the human being, a digitally encoded photograph or photographs, and other such information. Unlike the case of a file accessed through a path name, the representation of a resource is not a copy of the resource, but is instead some type of digitally encoded information with respect to the resource.

In the example RESTful API illustrated in FIG. 22, a client computer can use the verbs, or operations, of the HTTP protocol and the top-level URI 2212 to navigate the entire hierarchy of resources 2208 in order to obtain information about particular customers and about the orders that have been placed by particular customers.

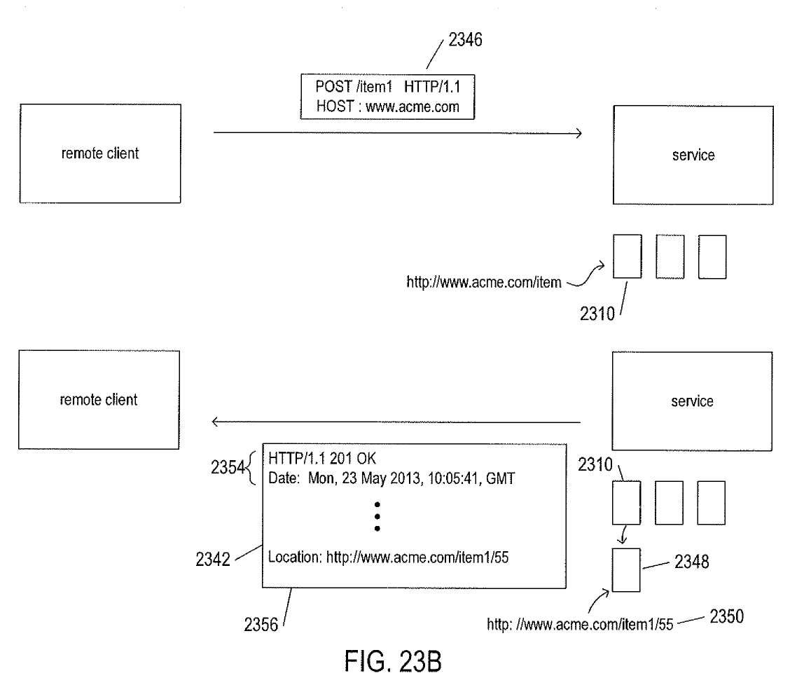

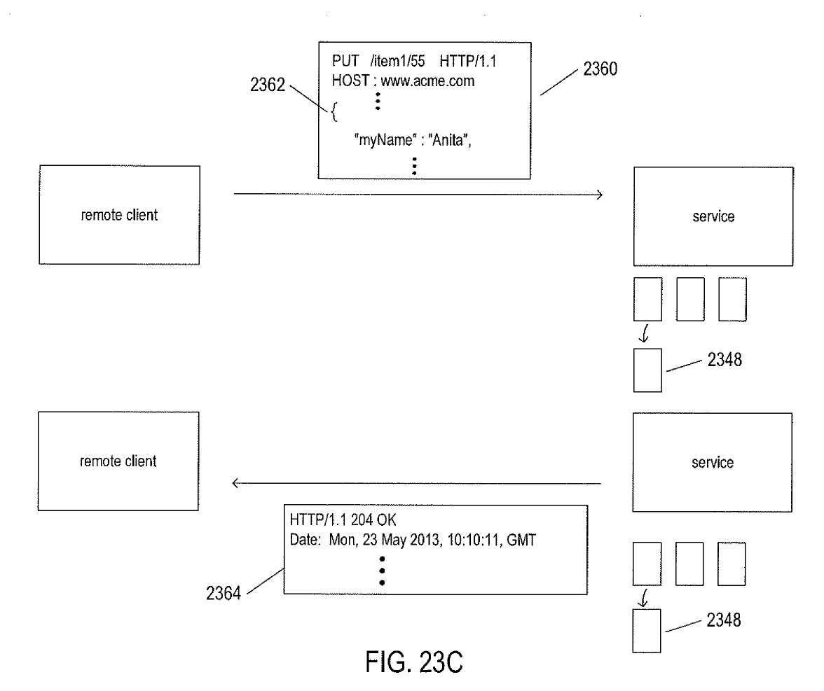

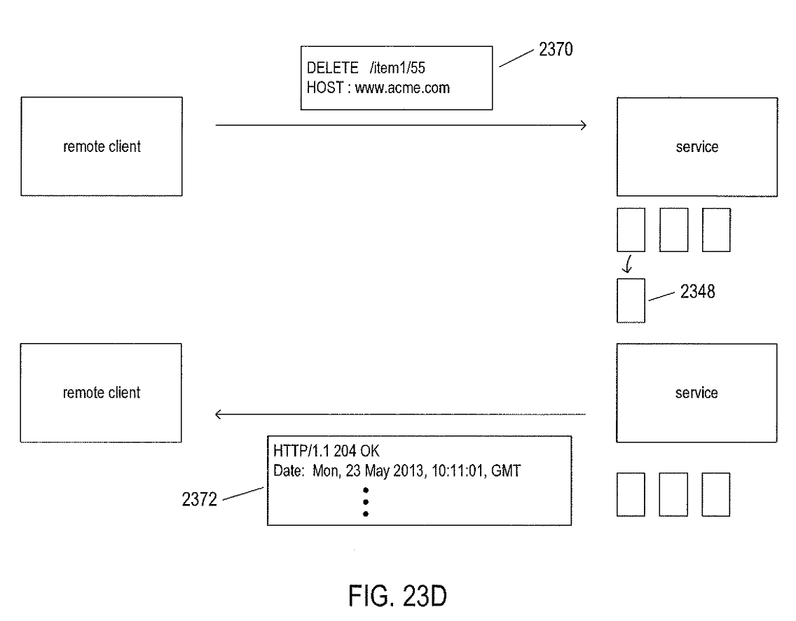

FIGS. 23A-D illustrate four basic verbs, or operations, provided by the HTTP application-layer protocol used in RESTful applications. RESTful applications are client/server protocols in which a client issues an HTTP request message to a service or server and the service or server responds by returning a corresponding HTTP response message. FIGS. 23A-D use the illustration conventions discussed above with reference to FIG. 22 with regard to the client, service, and HTTP protocol. For simplicity and clarity of illustration, in each of these figures, a top portion illustrates the request and a lower portion illustrates the response. The remote client 2302 and service 2304 are shown as labeled rectangles, as in FIG. 22. A right-pointing solid arrow 2306 represents sending of an HTTP request message from a remote client to the service and a left-pointing solid arrow 2308 represents sending of a response message corresponding to the request message by the service to the remote client for clarity and simplicity of illustration, the service 2304 is shown associated with a few resources 2310-2312.

FIG. 23A illustrates the GET request and a typical response. The GET request requests the representation of a resource identified by a URI from a service. In the example shown in FIG. 23A, the resource 2310 is uniquely identified by the URI “http://www.acme.com/item1” 2316. The initial substring “http://www.acme.com” is a domain name that identifies the service. Thus, URI 2316 can be thought of as specifying the resource “item1” that is located within and managed by the domain “http://www.acme.com.” The GET request 2320 includes the command “GET” 2322, a relative resource identifier 2324 that, when appended to the domain name, generates the URI that uniquely identifies the resource, and in an indication of the particular underlying application-layer protocol 2326. A request message may include one or more headers, or key/value pairs, such as the host header 2328 “Host:www.acme.com” that indicates the domain to which the request is directed. There are many different headers that may be included. In addition, a request message may also include a request-message body. The body may be encoded in any of various different self-describing encoding languages, often JSON, XML, or HTML. In the current example, there is no request-message body. The service receives the request message containing the GET command, processes the message, and returns a corresponding response message 2330. The response message includes an indication of the application-layer protocol 2332, a numeric status 2334, a textural status 2336, various headers 2338 and 2340, and, in the current example a body 2342 that includes the HTML encoding of a web page. Again, however, the body may contain any of many different types of information, such as a JSON object that encodes a personnel file, customer description, or order description. GET is the most fundamental and generally most often used verb, or function, of the HTTP protocol.

FIG. 23B illustrates the POST HTTP verb. In FIG. 23B, the client sends a POST request 2346 to the service that is associated with the URI “http://www.acme.com/item1.” In many RESTful APIs, a POST request message requests that the service create a new resource subordinate to the URI associated with the POST request and provide a name and corresponding URI for the newly created resource. Thus, as shown in FIG. 23B, the service creates a new resource 2348 subordinate to resource 2310 specified by URI “http://www.acme.com/item1,” and assigns an identifier “30” to this new resource, creating for the new resource the unique URI “http://www.acme.com/item1/36” 2350. The service then transmits a response message 2352 corresponding to she POST request back to the remote client. In addition to the application-layer protocol status, and headers 2354, the response message includes a location header 2356 with the URI of the newly created resource. According to the HTTP protocol, the POST verb may also be used to update existing resources by including a body with update information. However, RESTful APIs generally use POST for creation of new resources when the names for the new resources are determined by the service. The POST request 2346 may include a body containing a representation or partial representation of the resource that may be incorporated into stored information for the resource by the service.

FIG. 23C illustrates the PUT HTTP verb. In RESTful APIs, the PUT HTTP verb is generally used for updating existing resources or for creating new resources when the name for the new resources is determined by the client, rather than the service. In the example shown in FIG. 23C, the remote client issues a PUT HTTP request 2360 with respect to the URI “http://www.acme.com/item1/36” that names the newly created resource 2348. The PUT request message includes a body with a JSON encoding of a representation or partial representation of the resource 2362. In response to receiving this request, the service updates resource 2348 to include the information 2362 transmitted in the PUT request and then returns a response corresponding to the PUT request 2364 to the remote client.

FIG. 23D illustrates the DELETE HTTP verb. In the example shown in FIG. 23D, the remote client transmits a DELETE HTTP request 2370 with respect to URI “http://www.acme.com/item1/36” that uniquely specifies newly created resource 2348 to the service. In response, the service deletes the resource associated with the URL and returns a response message 2372.

As further discussed below, and as mentioned above a service may return, in response messages, various different links, or URIs, in addition to a resource representation. These links may indicate, to the client, additional resources related in various different ways to the resource specified by the URI associated with the corresponding request message. As one example, when the information returned to a client in response to a request is too large for a single HTTP response message, it may be divided into pages, with the first page returned along with additional links, or URIs that allow the client to retrieve the remaining pages using additional GET requests. As another example, in response to an initial GET request for the customer info resource (2210 in FIG. 22), the service may provide URIs 2220 and 2236 in addition to a requested representation to the client, using which the client may begin to traverse the hierarchical resource organization in subsequent GET requests.

### Highly Modularized Automated Application-Release-Management Subsystem

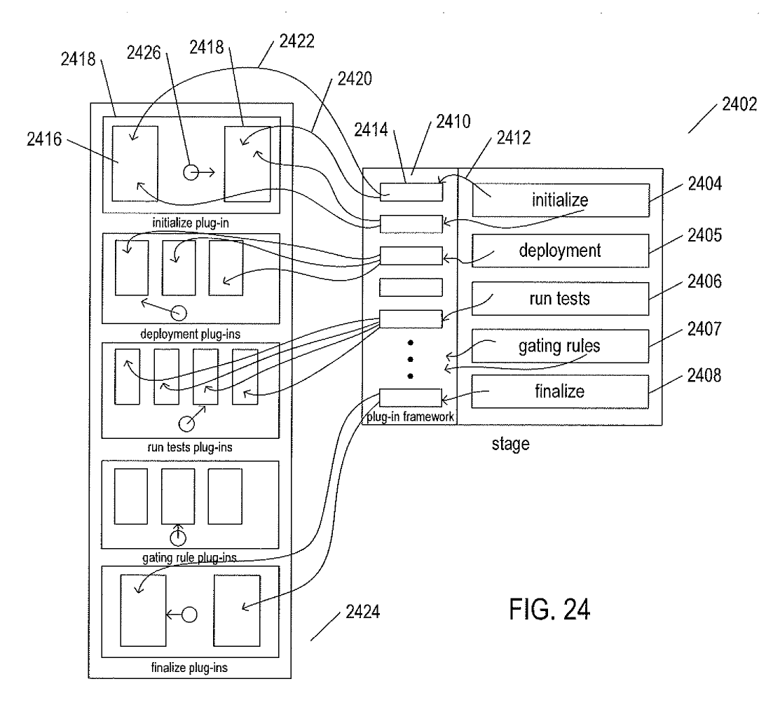

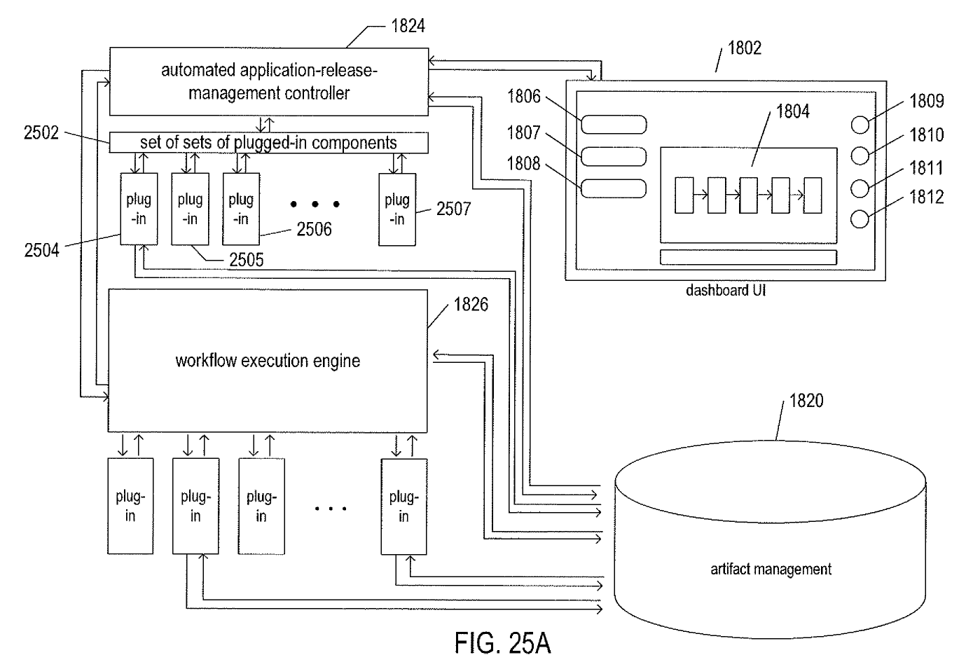

FIG. 24 illustrates additional details with respect to a particular type of application-release-management-pipeline stage that is used in pipelines executed by a particular class of implementations of the automated application-release-management subsystem. The application-release-management-pipeline stage 2402 shown in FIG. 24 includes the initialize 2404, deployment 2405, run tests 2406, gating rules 2407, and finalize 2408 tasks discussed above with respect to the application-release-management-pipeline stage shown in inset 1916 FIG. 19. In addition, the application-release-management-pipeline stage 2402 includes a plug-in framework 2410 that represents one component of a highly modularized implementation of an automated application-release-management subsystem.

The various tasks 2407-2408 in the pipeline stage 2402 are specified as workflows that are executed by a work-flow execution engine, as discussed above with reference to FIGS. 18-20B. In the currently described implementation, these tasks include REST entrypoints which represent positions within the workflows at each of which the workflow execution engine makes a callback to the automated application-release-management subsystem. The callbacks are mapped to function and routine calls represented by entries in the plug-in framework 2410. For example, the initialized task 2404 includes a REST endpoint that is mapped, as indicated by curved arrow 2412, to entry 2414 in the plug-in framework, which represents a particular function or routine that is implemented by one or more external modules or subsystems interconnected with the automated application-release-management subsystem via a plug-in technology. These plug-in framework entries, such as entry 2414, are mapped to corresponding routine and function calls supported by each of one or more plugged-in modules or subsystems. In the example shown in FIG. 24, entry 2414 within the plug-in framework that represents a particular function or routine called within the initialized task is mapped to a corresponding routine or function in each of two plugged-in modules or subsystems 2416 and 2418 within a set of plugged-in modules or subsystems 2418 that support REST entrypoints in the initialized task, as represented in FIG. 24 by curved arrows 2420 and 2422. During pipeline execution, callbacks to REST entrypoints in tasks within application-release-management pipelines are processed by calling the external routines and functions to which the REST entrypoints are mapped.

Each stage in an application-release-management pipeline includes a stage-specific plug-in framework, such as the plug-in framework 2410 for stage 2402. The automated application-release-management subsystem within which the stages and pipelines are created and executed is associated with a set of sets of plugged-in modules and subsystems, such as the set of sets of plugged-in modules and subsystems 2424 shown in FIG. 24. A cloud-computing facility administrator or manager, when installing a workflow-based cloud-management system that incorporates the automated application-release-management subsystem or reconfiguring the workflow-based cloud-management system may, during the installation or configuration process, choose which of the various plugged-in modules and subsystems should be used for executing application-release-management pipelines. Thus, the small selection features, such as selection feature 2426 shown within the set of sets of plugged-in modules and subsystems 2424, indicates that, in many cases, one of the multiple different plugged-in modules or subsystems may be selected for executing application-release-management-pipeline tasks. This architecture enables a cloud-computing-facility administrator or manager to select particular external modules to carry out tasks within pipeline stages and to easily change out, and substitute for, particular plugged-in modules and subsystems without reinstalling the workflow-based cloud-management system or the automated application-release-management subsystem. Furthermore, the automated application-release-management subsystem is implemented to interface to both any currently available external modules and subsystems as well as to external modules and subsystems that may become available at future points in time.

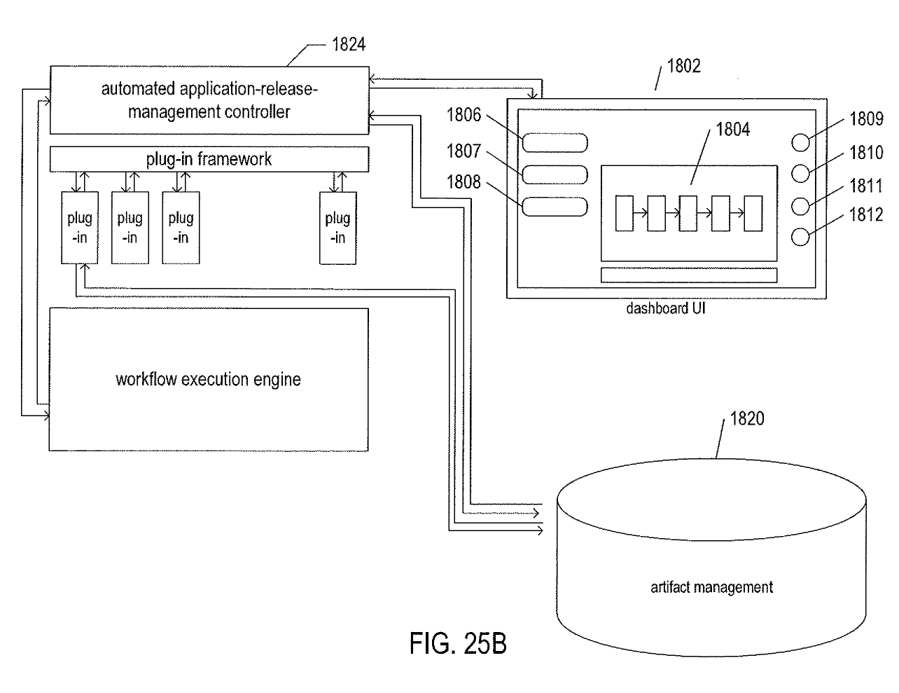

FIGS. 25A-B illustrate a highly modularized automated application-release-management subsystem. The components previously shown in FIG. 18 are labeled with the same numeric labels in FIG. 25A as in FIG. 18. As shown in FIG. 25A, the automated application-release-management controller 1824 includes or interfaces to the set of sets of plugged-in modules and subsystems 2502, discussed above as set of sets 2424 in FIG. 24. This set of sets of plugged-in modules and subsystems provides a flexible interface between the automated application-release-management controller 1824 and the various plugged-in modules and subsystems 2504-2507 that provide implementations of a variety of the REST entrypoints included in task workflows within pipeline stages. The highly modularized automated application-release-management subsystem thus provides significantly greater flexibility with respect to external modules and subsystems that can be plugged in to the automated application-release-management subsystem in order to implement automated application-release-management-subsystem functionality.

As shown in FIG. 25B, the highly modularized automated-application-release-management subsystem additionally allows for the replacement of the workflow execution engine (1826 in FIG. 25A) initially bundled within the workflow-based cloud-management system, discussed above with reference to FIG. 23, by any of alternative, currently available workflow execution engines or by a workflow execution engine specifically implemented to execute workflows that implement application-release-management-pipeline tasks and stages. Thus, as shown in FIG. 25B, a different workflow execution engine 2520 has been substituted for the original workflow execution engine 1826 in FIG. 25A used by the automated application-release-management subsystem to execute pipeline workflows. In essence, the workflow execution engine becomes another modular component that may be easily interchanged with other, similar components for particular automated-application-release-management-subsystem installations.

### Parameter-Value Exchanges Between Tasks of an Application-Release-Management Pipeline

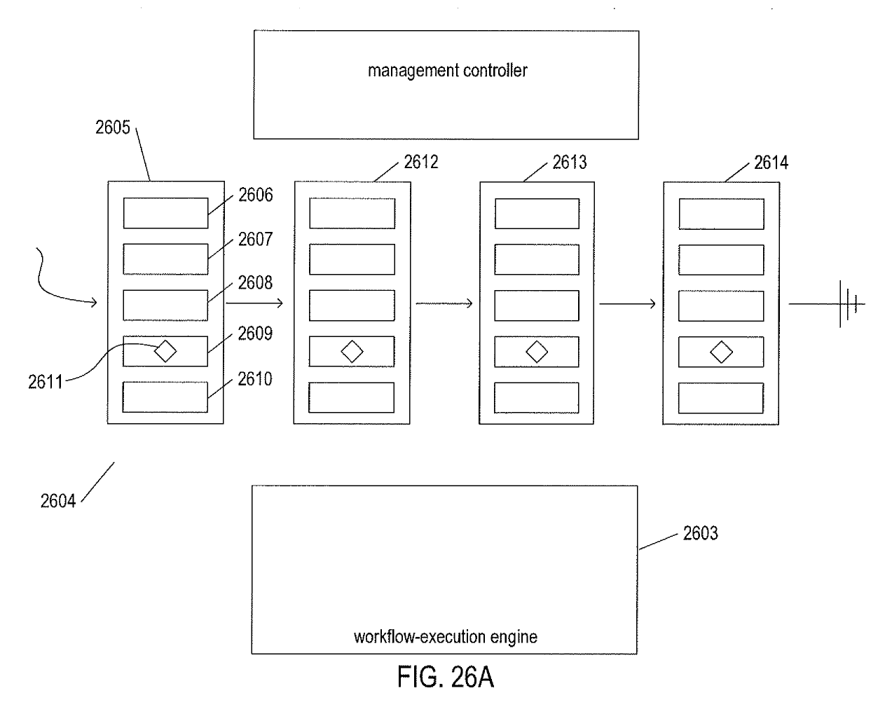

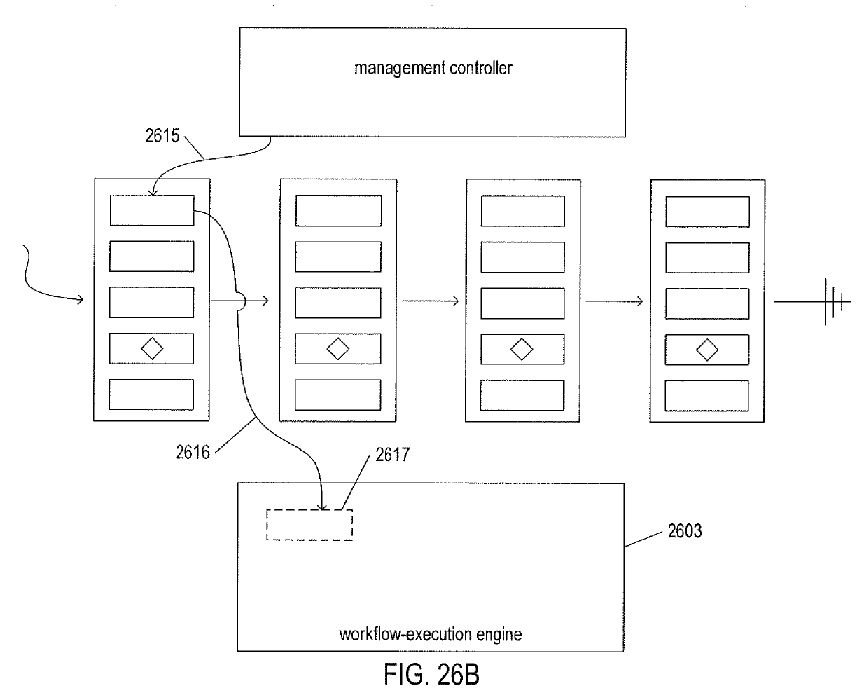

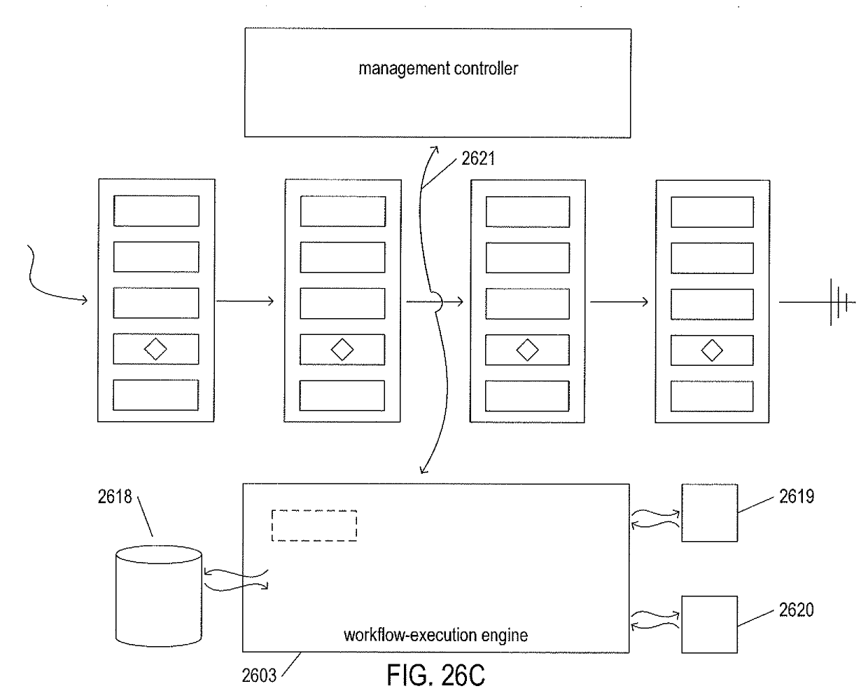

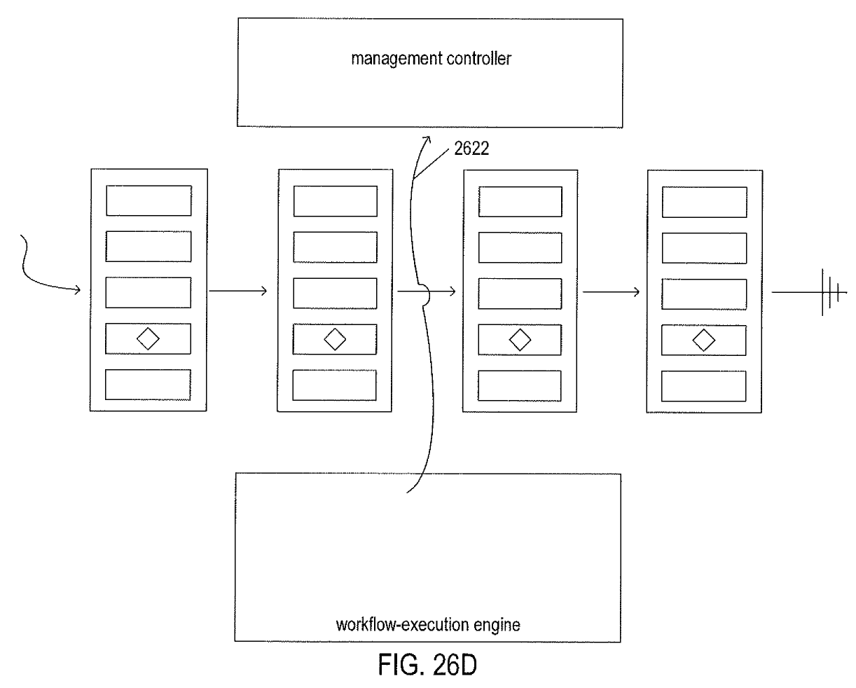

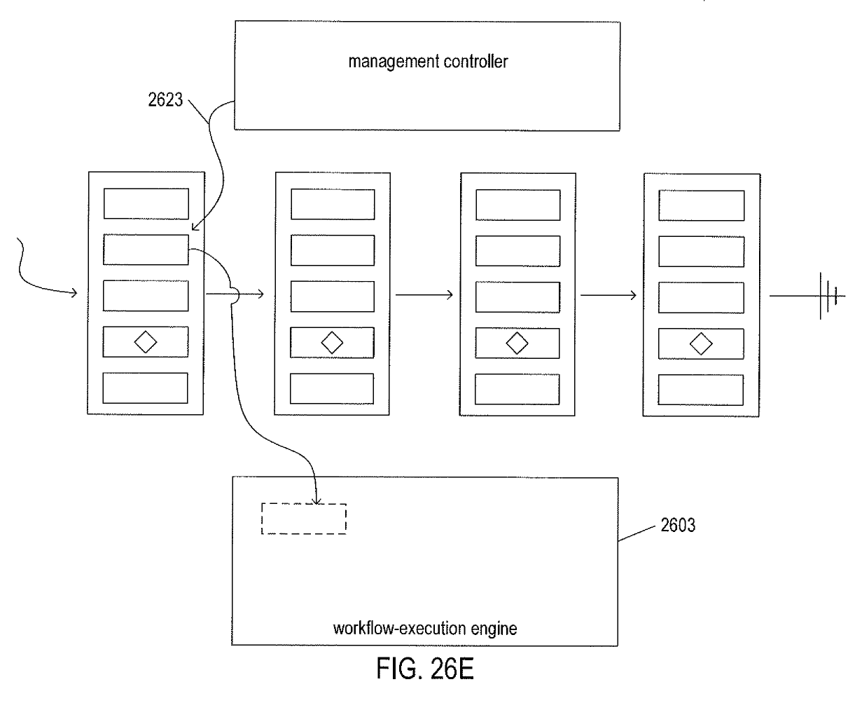

FIGS. 26A-E illustrate task execution controlled by an automated-application-release-management-subsystem management controller, subsequently referred to as a “management controller” in this document. The illustration conventions used in FIG. 26A are used for FIGS. 26B-E and are similar to the illustration conventions used in FIGS. 22A-F. These illustration conventions are next described with reference to FIG. 26A.

In FIG. 26A, the application-release-management-pipeline execution machinery within an automated-application-release-management subsystem, discussed above with reference to FIGS. 18-208, as shown using block-diagram illustration conventions. This application-release-management-pipeline execution machinery includes the management controller 2602 and the workflow-execution engine 2603. A four-stage pipeline 2604 is shown in the center of FIG. 26A. Each stage, including the first stage 2605, includes a number of tasks, such as tasks 2000-2610 in stage 2605. The gaiting-rule task 2609 is illustrated with a conditional-step symbol 2611. Similar illustration conventions are used for the remaining three stages 2612-2614.

As shown in FIG. 26B, in the initial steps of task execution, the management controller selects a next task for execution, as represented by curved arrow 2615 in FIG. 26B, and then forwards a reference to this task along with any input-parameter values required for task execution to the workflow-execution engine, as represented in FIG. 26B by curved arrow 2616 and the task image 2617 within the workflow-execution engine 2603.

Next as shown in FIG. 26C, the workflow-execution engine executes the task. This execution may involve, as discussed above, storage and retrieval of data from an artifact-management subsystem 2618, various routine and function calls to external plug-in modules, routines, and subsystems 2619-2620, and various task-execution operations carried out by the workflow-execution engine 2603. During execution of the task, as discussed above, the workflow-execution engine may make callbacks to the management controller that results in information exchange in one or both directions, as represented by double-headed arrow 2621 in FIG. 26C.

As shown in FIG. 26D, when execution of the task completes, the workflow-execution engine notifies the management controller, as represented by curved-arrow 2622. The management controller carries out various task-completion operations, including, in many cases, receiving and processing output parameters output by execution of the task.

Next, as shown in FIG. 26E, the management controller selects a next task to execute, represented by curved arrow 2623 in FIG. 26E, and forwards a reference to this task to the workflow-execution engine 2603, which executes the task, as discussed above. This process continues for each task of each stage of the pipeline.

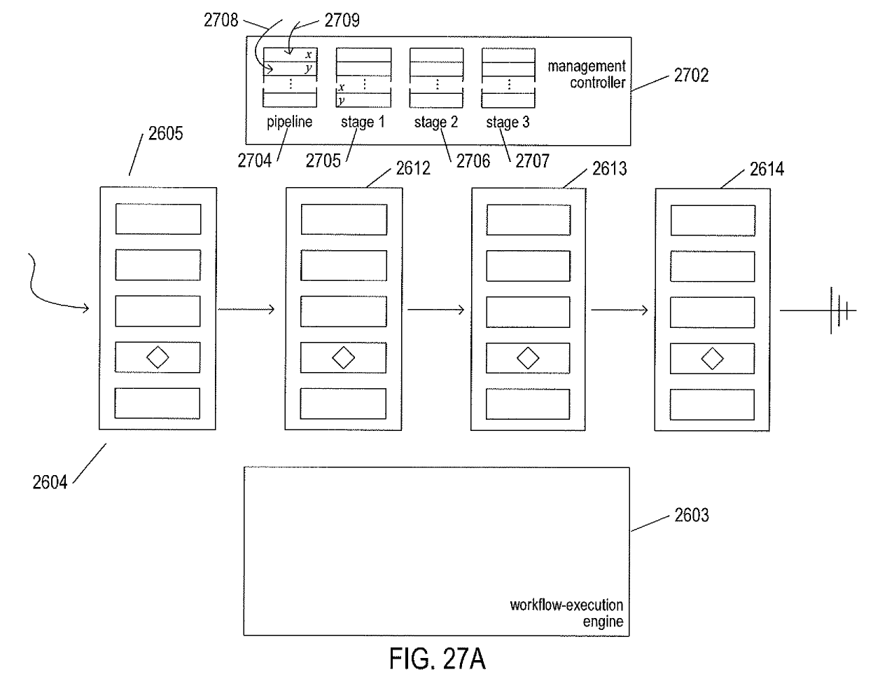

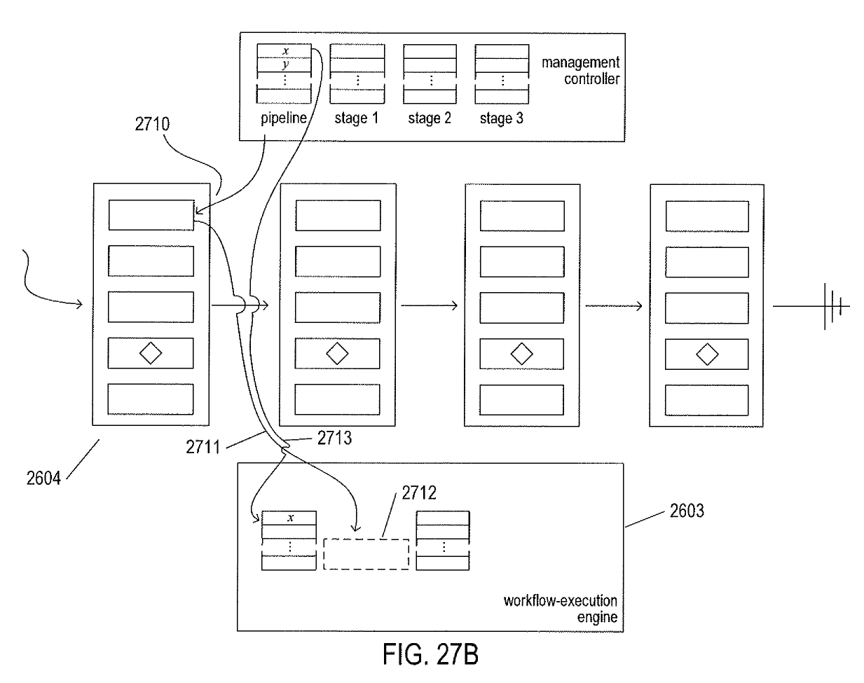

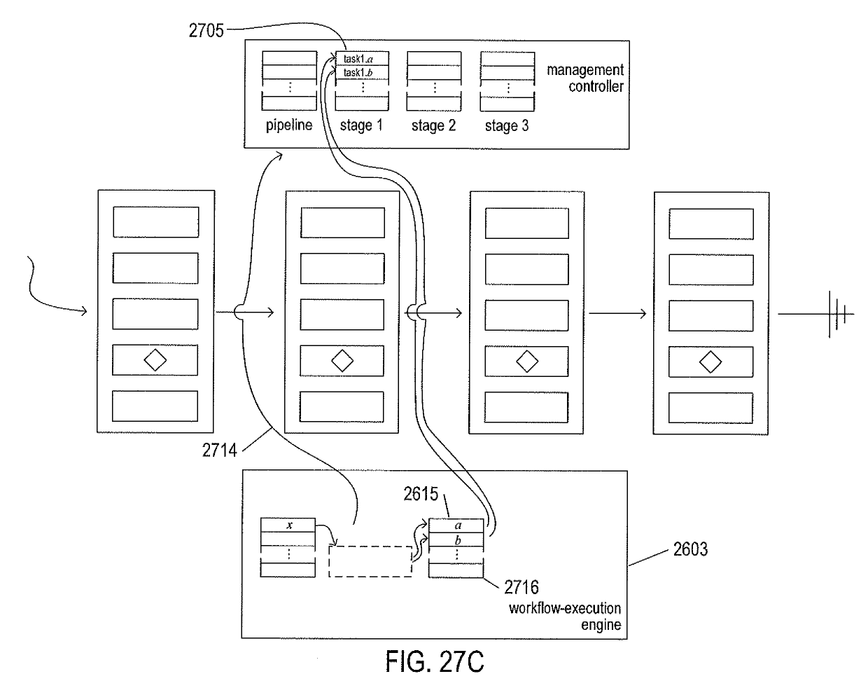

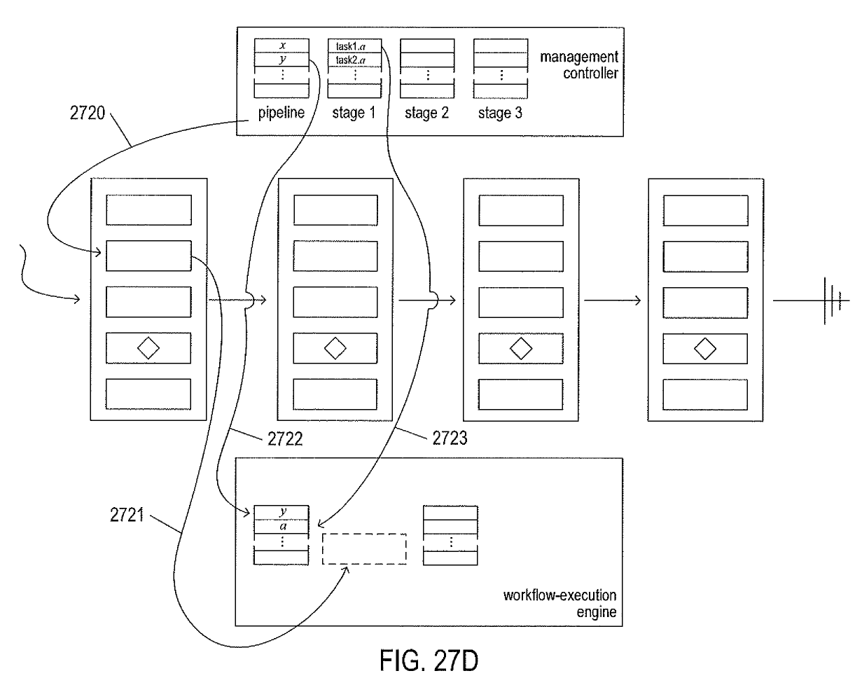

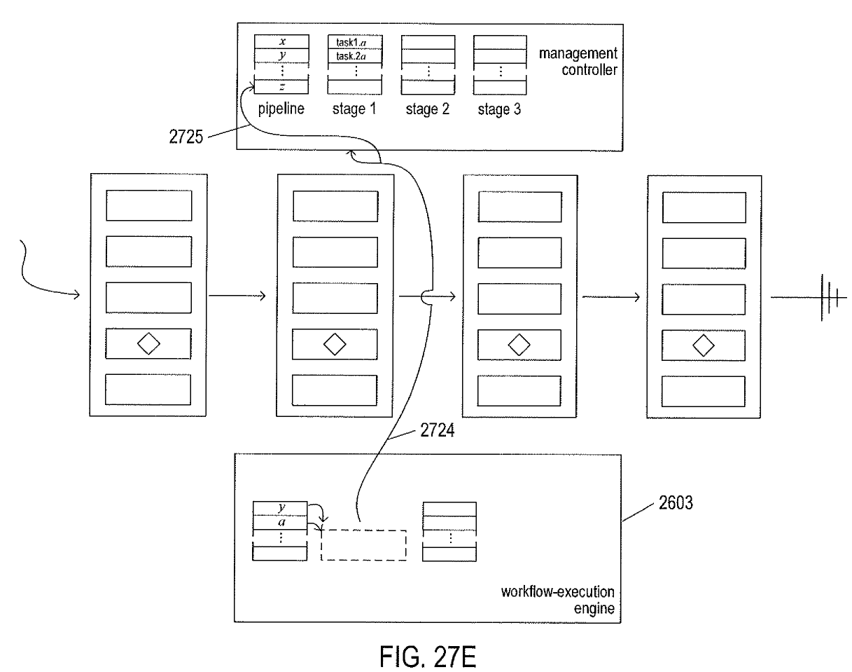

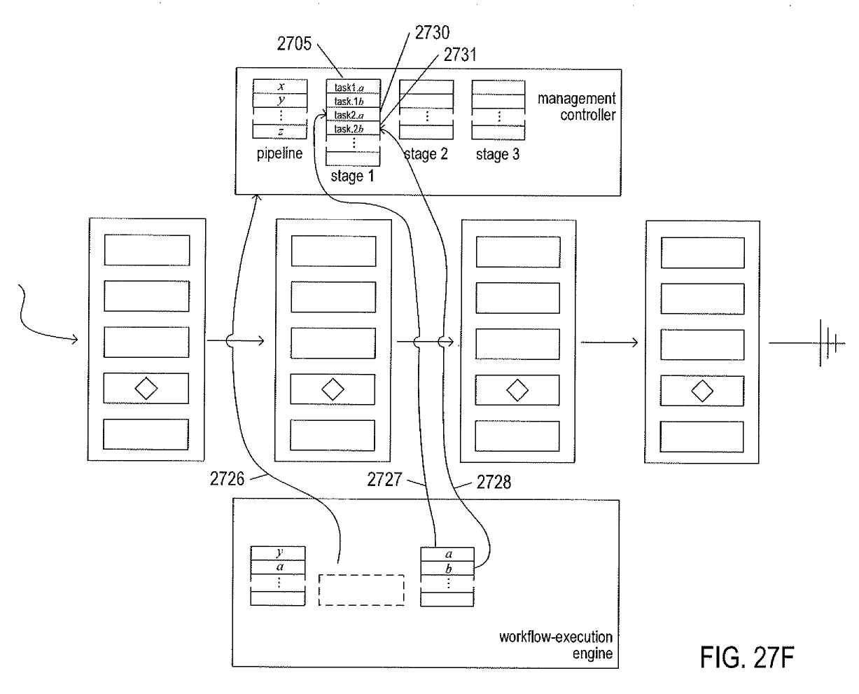

FIGS. 27A-F illustrate parameter passing between tasks provided by management controller. This management controller, and the automated-application-release-management subsystem in which the management controller operates, provides for information exchange between tasks of an executing pipeline.

As shown in FIG. 27A, the management controller 2702 includes parameter-value storage arrays 2704-2707 that reside in memory and that are accessible from within the execution context of the management controller. These memory-resident parameter-value arrays are maintained over the course of execution of any particular pipeline. The first an array 2704 stores pipeline parameters that serve a role similar to global variables in structured programming languages. The values of these parameters are available prior to and throughout execution of each pipeline. The remaining memory-resident parameter-value arrays 2705-2707 contain parameter values output by tasks during execution of each of the first three stages 2605 and 2612-2613 of pipeline 2604. When the pipeline has a greater number or fewer stages, there are a greater number or fewer stage-specific memory-resident parameter-value arrays maintained in the execution context of the management controller. While shown as arrays in the example of FIGS. 27A-F, the parameter values may be alternatively stored in linked lists, associative parameter-value data storage, and in other types of data-storage data structures. In alternative implementations there may be a separate memory-resident data structure for each task of each stage. In FIG. 27A, the management controller is preparing to execute pipeline 2604. The pipeline, using features described below, is specified and configured to provide for pipeline parameters that are associated with the pipeline and maintained in memory during extension of the pipeline. In FIG. 27A, the management controller initializes two of the pipeline parameter to have the values x and y, as indicated by curved arrows 2708 and 2709 in FIG. 27A.

FIG. 27B shows launching of a first task for execution by the management controller. As discussed previously, the first task is selected 2710 by the management controller and transferred to the workflow-execution engine 2603, as indicated by curved arrow 2711 and task image 2712. In addition, because the pipeline has been developed to access parameter variables, and because the first task includes a mapping or specification of the first pipeline variable as the first input parameter to the task, the management controller, as indicated by curved arrow 2712, extracts the first value from the pipeline parameter-value array and passes the parameter value as the first input value for the first task to the workflow-execution engine, as represented by curved arrow 2713.

FIG. 27C shows execution and task-execution completion for the first task. As shown in FIG. 27C, when execution of the first task is completed, the workflow-execution engine 2603 notifies the management controller of task completion, as indicated by curved arrow 2714 in FIG. 27C. The output parameters from the first task, with values a 2715 and b 2716, are retrieved by the management controller and entered into the parameter-value memory-resident array 2705 for the first stage. Note that the parameter values are stored with task specifiers, as in the example of the task-specifier parameter value “task 1.a.” As mentioned above, in alternative implementations, there may be a separate memory-resident parameter-value array for each task of each stage, in which case the task specifiers would not be needed.

FIG. 27D shows launching of a second task by the management controller. The management controller selects the second task 2720 for execution and forwards that task to the workflow-execution engine 2721. The second task has been developed to receive as input parameter values, the second pipeline parameter value and the first parameter value output by the previously executed task. The management controller finds the stored parameter values specified for input to the second task and furnishes these values to the workflow-execution engine as represented by curved arrow 2722 and 2723. Values may be specified as arguments to a task-execution command, which includes a reference to the task to be executed, or may be alternatively specified, depending on the workflow-execution-engine API.

As shown in FIG. 27E, during execution of the second task, the workflow-execution engine 2603 may make a callback, as represented by curved arrow 2724, to the management controller. In the example shown in FIG. 27E, the callback involves passing a parameter value to the management controller to store as the current value of a pipeline variable, as indicated by curved arrow 2725. In other callbacks, the value of a pipeline parameter may be fetched and returned to the workflow-execution engine. Event-reporting callbacks were discussed above with reference to FIG. 20B. Thus, the values of pipeline parameters may be used as global variables for pipeline-task execution.

FIG. 27F shows execution and completion of execution of the second task. When the second task finishes executing, as indicated by curved arrow 2726 in FIG. 27F, the management controller is notified. The management controller receives, as indicated by curved arrows 2727 and 2728, the values of two output parameters from the workflow-execution controller output by the second task and stores these parameter values in entries 2730 and 2731 of the memory-resident parameter-value array 2705 with task specifiers indicating that they are output by task 2. These parameter values, along with the previously stored output parameter values from task 1, are now available for input to subsequently executed tasks of the current stage and subsequently executed stages.

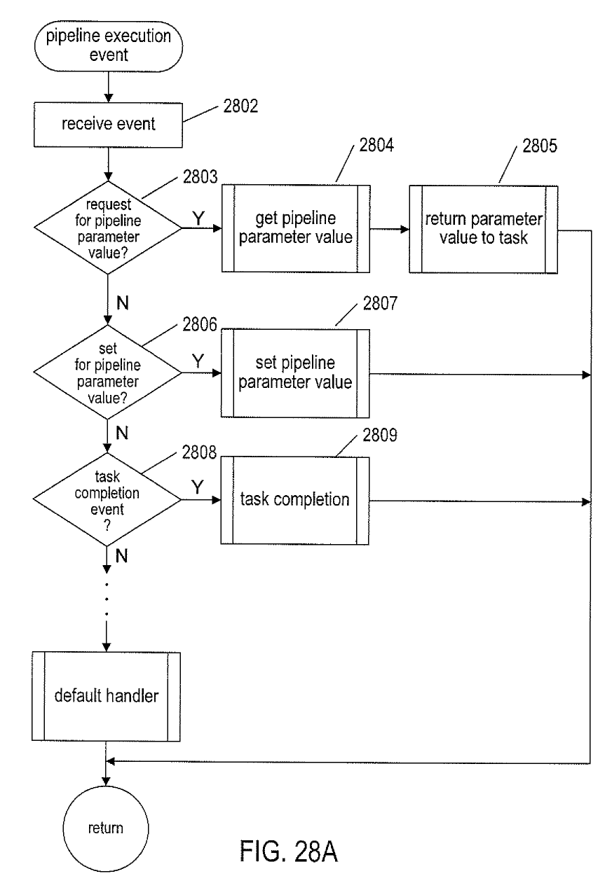

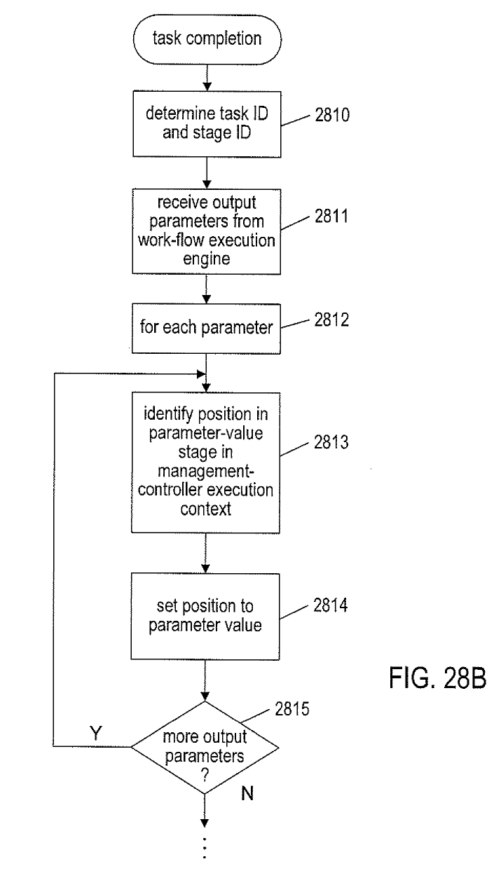

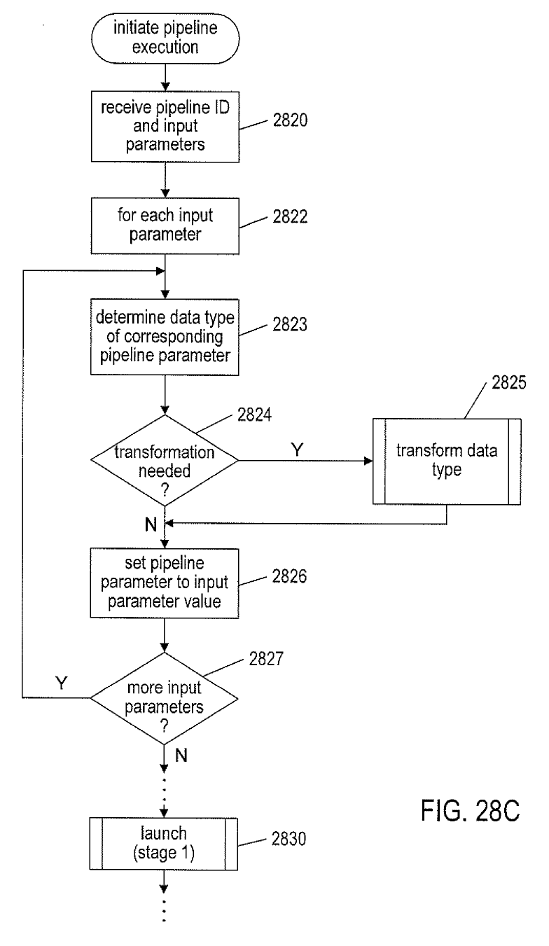

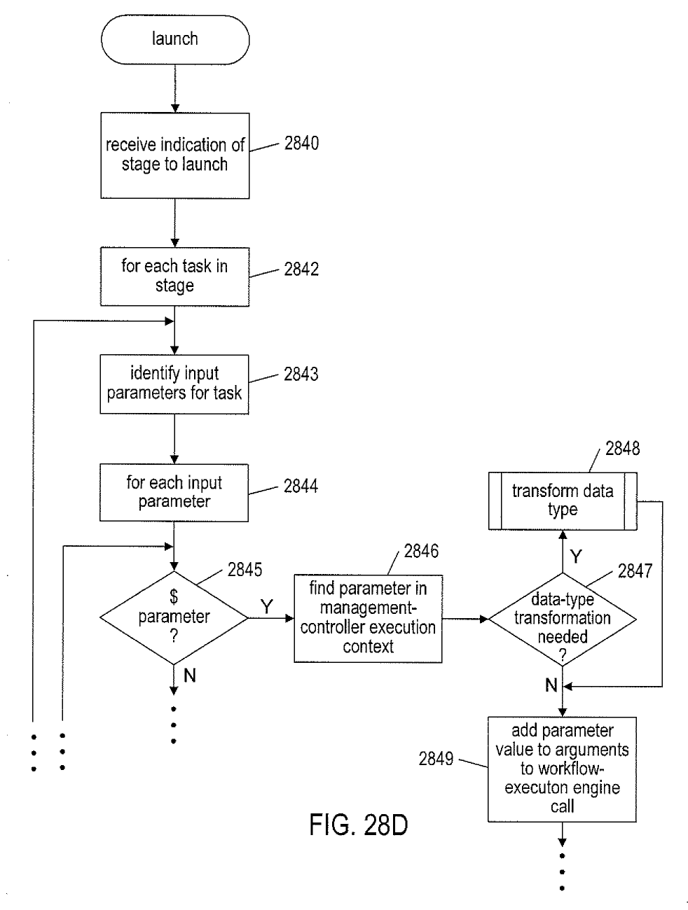

FIGS. 28A-D provide extracts of control-flow diagrams to indicate how, in one implementation, the management controller provides for inter-task information exchange. FIG. 28A shows a partial implementation of the pipeline-execution-event routine called in step 2028 of FIG. 20B. In step 2802, the pipeline-execution-event routine receives an indication of the pipeline-execution event that needs to be handled. When the event is a request, by the workflow-execution engine, for a parameter value via a callback as determined in step 2803, then, in step 2804, the management controller accesses the specified pipeline parameter value in the memory-resident pipeline-parameter-value array and returns that value to the workflow-execution engine for task execution, in step 2806. Otherwise, when the evens is a request to set a pipeline-parameter value via a callback by the workflow-execution engine, as determined in step 2806, then the management controller sets the specified pipeline parameter to the indicated value in step 2807. When the event is a task-completion event, as determined in step 2808, then a task-completion handler is called in step 2809.

FIG. 28B shows a partial implementation of the task-completion handler called in step 2809 of FIG. 28A. In step 2810, the task-completion handler determines the identifier of the currently executing task and stage that includes the currently executing task. In step 2811, the task-completion handler receives the output parameters from the workflow-execution engine. Then, in the for-loop of steps 2812-2815, the task-completion handler considers each output parameter returned by the task, execution of which just completed. In step 2813, the task-completion handler identifies the position in which to place the returned parameter value within a memory-resident parameter-value array in the management-controller execution context. Then, in step 2814, the value at that position is set to the returned parameter value.

FIG. 28C shows a partial implementation of the initiate-pipeline-execution handler called in step 2024 in FIG. 20B. In step 2820, the initiate-pipeline-execution handler receives a pipeline ID and input parameters. In the for-loop of steps 2822-2827, the handler considers each received input parameter. In step 2823, the handler determines the data type of the corresponding pipeline parameter. In step 2824, the handler determines whether a data-type transformation is needed to transform the input parameter to a stored pipeline-parameter value. When a transformation is needed, a transformation-data-type routine is called in step 2825. In step 2826, the handler sets the pipeline parameter corresponding to the input parameter to the input parameter value. In a subsequent step 2830, the initiate-pipeline-execution handler launches the first stage of a pipeline.

FIG. 28D shows a partial implementation of the launch routine called in step 2830 of FIG. 28C. In step 2840, the launch routine receives an indication of a stage for which execution needs to be initiated. In the for-loop of steps 2842-2849, each task in the stage is launched. For the currently considered task, she launch routine identifies the input parameters for the task in step 2843. For each input parameter, in an inner for-loop comprising steps 2844-2849, each of the input parameters is considered. When the input parameter is an inter-task parameter as determined in step 2845, then, in step 2846, the launch routine finds the parameter in the management-controller execution context. When a data type transformation is needed for the parameter, as determined in step 2847, the stored parameter value is transformed, in step 2848. In step 2849, the parameter value is added as an argument to a workflow-execution-engine call to launch execution of the currently considered task. In steps not shown in FIG. 28D, the launch routine waits for execution to continue before launching execution of a subsequent task.

### Aspect Orienting Programming

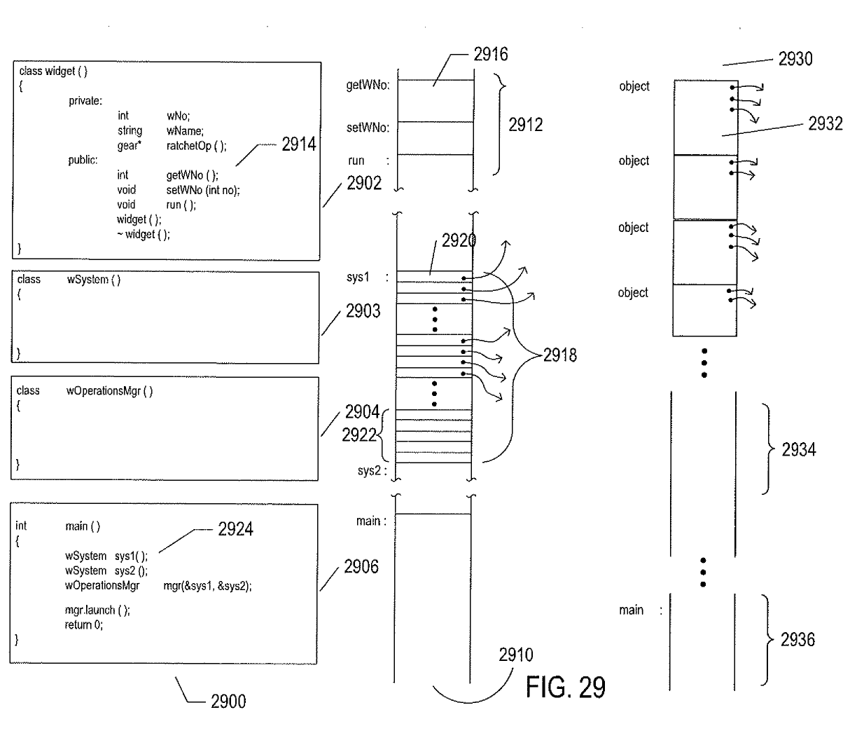

FIG. 29 illustrates a symbolically encoded computer program and a corresponding physical, in-memory implementation of the computer program. A symbolically encoded computer program 2900 may include a symbolic encoding of a number of different classes 2902-2904 and a main routine 2906 that together specify a set of instructions that are stored in memory for execution by one or more processors within a processor-controlled device, machine, or system. In many modern programming environments, objects instantiated during execution of a computer program correspond to symbolically encoded classes. In FIG. 29, a virtual address space 2910 composed, in general, of instruction-storage and data-storage faculties provided as physical address spaces both by one or more electronic memories and one or more non-volatile mass-storage devices, is shown as a column, according to conventional illustration techniques. The function members of classes are generally compiled into sets of sequentially organized processor instructions that reside in one portion of memory 2912. For example, the function member “getWNo” 2914 of the widget class 2902 is compiled into a set of instructions represented by block 2916 associated with a symbolic entry point or initial memory address. An object may be instantiated for a class by allocating and configuring a portion of the address space, such as address-space portion 2918, to include references to entry points corresponding to member functions of the object as well as memory locations for object data members and/or references to object data members. For example, the instantiated object 2918 is instantiated from the wSystem class 2903 and contains references, such as reference 2920, to entry points of function members of the object as well as storage locations 2922 in memory for storing the values of object data members and references to data members located elsewhere in memory. This particular object sys1, is instantiated in an initial line 2924 of the main routine 2906.

The in-memory implementation of the symbolically encoded program, shown in FIG. 29, is relatively simplistic. In actual devices, machines, and systems, the mappings from symbolic encodings of computer programs to a virtual address space that represents various different electronic memories and storage space within mass-storage devices may be complex. FIG. 29 also shows, in a right-hand column 2930, a simplified representation of the in-memory implementation of the symbolically encoded computer program 2900 as a set of in-memory resident object instantiations, such as object instantiation 2932, a region of processor instructions corresponding to routines called from object instantiations 2934, and processor instructions stored within memory that represent the main routine 2936. The memory of a functioning processor-controlled device also includes large numbers of operating-system routines, library code, and many other types of control functionalities implemented as stored processor instructions that provide computational facilities and an execution environment for computer programs.

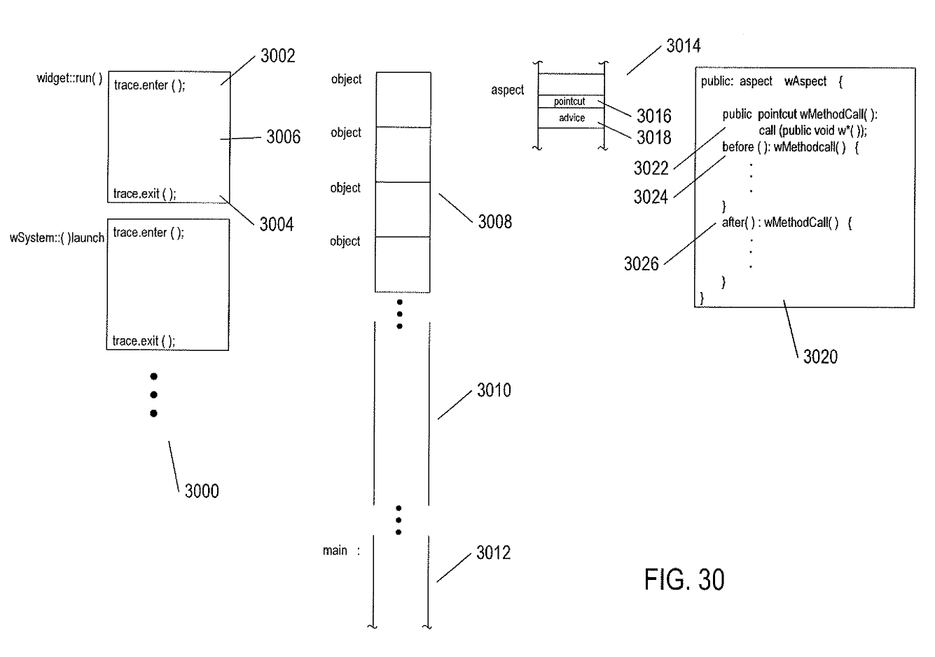

FIG. 30 illustrates the aspect-oriented-programming (“AOP”) approach to implementing crosscutting functionality. In the left column of FIG. 30 3000, the manual instrumentation of routines illustrated. In this case, in order to generate a trace of data frames, as discussed above with reference to FIG. 30, a program developer has introduced routine calls to a trace object at the beginning 3002 and end 3004 of each routine, such as routine 3006. As discussed above, this technique is expensive in time, error-prone, relatively inflexible, and contrary to modern program-development strategies, including object-oriented programming.

During the past decade, AOP techniques and facilities have been developed. In one AOP approach, in addition to object instantiations 3008, routines 3010, and a main program 3012, an in-memory implementation of the program may additionally include one or more aspects 3014, each aspect including a pointcut definition 3016 and executable code 3018 that is inserted at those points during program execution identified by the pointcut, referred to as “advice.” FIG. 30 shows a symbolic encoding of a simple aspect 3020, in which the pointcut definition 3022 identifies various routines into which advice should be inserted and the “before” and “after” routines 3024 and 3026 specify advice code to be executed prior to and following execution of the routines identified by the pointcut during program execution. Of course, there are many different programming-language syntaxes and facilities that can be used to define aspects, the example shown in FIG. 30 is intended only to illustrate the fact that aspects can be symbolically encoded, rather than provide an example of how the encoding is carried out. Aspects thus provide an elegant tool for introducing crosscutting facilities into a computer program. Rather than introducing routine calls in each routine, as in the symbolic code 3000 shown on the left side of FIG. 30, a programmer need only develop an appropriate aspect for the program, and the desired crosscutting functionality is automatically included during program execution. As discussed further, below, the aspect may be initially compiled to byte code, and advice then inserted into executable code during final interpretation and/or compilation of byte code by a virtual machine, in certain systems.

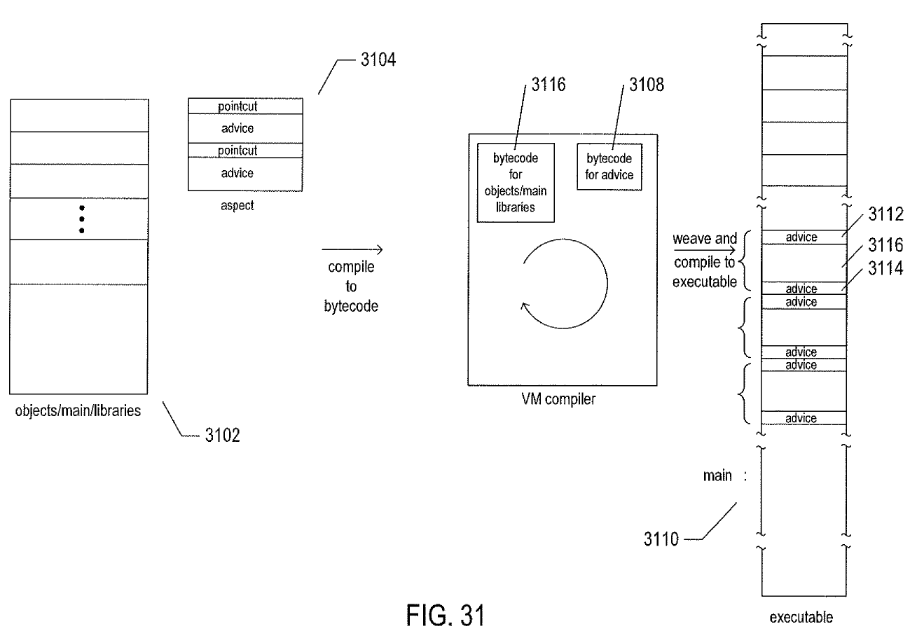

FIG. 31 illustrates a method by which AOP-defined instrumentation is included during program execution. In certain modern programming languages, such as Java, symbolically encoded program code is initially compiled to intermediate byte code, also referred to as “byte code” and “intermediate code,” which is then interpreted and/or compiled by a virtual machine into executable code for execution on particular devices, machines, and systems. As shown in FIG. 31, a program, including class declarations and implementations and a main program, in addition to various libraries and system code 3102 and an aspect 3104, which includes one or more pointcuts and associated advice, are separately compiled into byte code for the program 3106 and byte code for the aspect advice 3108. A virtual machine then generates, from these two sets of byte code, an executable 3110 or portions of executable code stored in an address space. The process by which the program byte code and aspect byte code is merged is referred to as “weaving.” In the case of an aspect that includes pointcuts that identify points in time, during execution, corresponding to the entering of routines and exiting from routines, a virtual machine introduces the advice corresponding to the pointcuts into the code for those routines selected by the pointcuts, during executable-code generation. For example, as shown in FIG. 31, advice to be executed prior to and following execution of particular routines has been introduced by the virtual machine at the beginning 3112 and at the end 3114 of particular routines, such as routine 3116. It may alternatively be possible to combine intermediate program code and aspect program code and then interpret or compile the combined program and aspect intermediate code.

Pointcuts can be used to identify any of various different subsets of points in the execution of a program, referred so as “joinpoints.” Joinpoints may include any type of point during the execution of a program that may be defined, including the beginning of execution of routines, immediately following execution of routines, access to particular memory locations, and other such definable points that may arise during the execution of a routine. For example, considering the joinpoints corresponding to the beginning of execution of all routines, which can be defined as points at which routine-call instructions are executed, a pointcut may be used to define a subset of these joinpoints comprising the points in the execution of the program corresponding to routine-call instructions for only a subset of the routines of the program, such as the member functions of a particular class or instantiated object. Thus, aspect definition is quite general, and allows for introduction of functionality at arbitrarily selected defined points during the execution of a program. In the following examples collection of data frames for trace analysis, as discussed above with reference to FIG. 30, is implemented using an aspect, such as aspect 3020 discussed with reference to FIG. 30, which results in introduction of executable trace code immediately prior to and immediately following execution of each of a definable set of routines. However, techniques similar to those discussed below can be used for code inserted at other types of joinpoints.

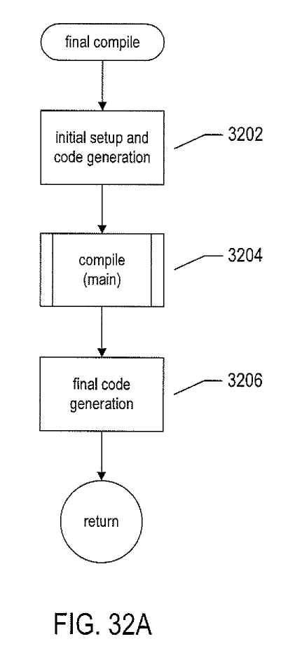

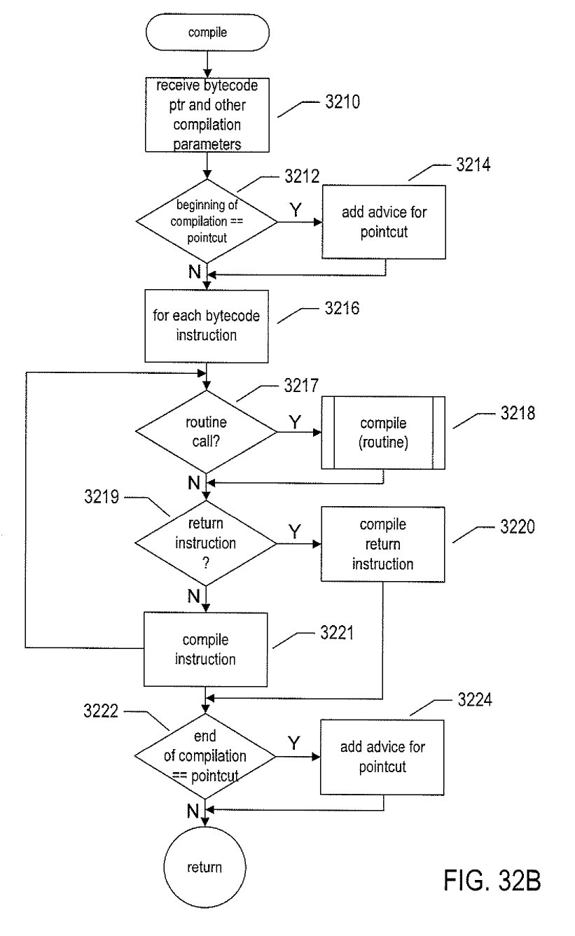

FIGS. 32A-B illustrate the final interpretation or compilation of program byte code and aspect byte code by a virtual machine in a weaving process. In this discussion the phrase “final compile” and the term “compile” is used to mean either byte code interpretation, compilation of byte code into machine instructions, or, as is often the case, a combination of interpretation and compilation that produces executable code that is executed by underlying computer hardware following generation of the executable code by a virtual machine to which the program byte code and aspect byte code is furnished. FIG. 32A shows a routine “final compile.” In a first step 3202 of this routine, program and aspect byte code corresponding to a program is received by a virtual machine that carries out any initial setup tasks and initial code generation that precedes generation of executable code corresponding to a program. Then, in step 3204, the routine “final compile” calls a routine “compile” to begin generating executable code for the main routine of the program and for routines called from the main routine. Finally, in step 3206, the virtual machine carries out any additional code generation and other tasks needed to provide executable code to underlying hardware corresponding to the initially received program and aspect byte code.

FIG. 32B provides a control-flow diagram for the routine “compile” called in step 3204 of FIG. 32A. In step 3210, the routine “compile” receives a byte code pointer to the beginning of a routine to compile and any other various compilation parameters. In step 3212, the routine “compile” determines whether the current execution point corresponding to the beginning of compilation of a routine corresponds to a point of execution defined by a pointcut within the aspect byte code. When the current point of execution corresponds to a pointcut, any advice corresponding to that pointcut is appended to the byte code for the routine, in step 3214. Next, in the for-loop of steps 3210-3221, the routine “compile” compiles each byte code instruction into executable code. When the instruction is a routine call, as determined in step 3217, the routine “compile” is recursively called in step 3218. When the next instruction is a return instruction, terminating the routine for which code is currently being generated, code for the return instruction is generated in step 3220, terminating the for-loop of steps 3216-3221. Following generation of code for the return, the routine “compile” determines whether the current point of execution, following execution of the routine, corresponds to a point of execution defined by a pointcut in the aspect, in step 3222. When the current point of execution corresponds to a pointcut, code is generated for the advice corresponding to that pointcut in step 3224.

### Automated-Application-Release-Management Subsystem that Includes Advice-Based Crosscutting Functionality

The current document is directed to an automated-application-release-management subsystem that includes support for inserting crosscutting functionality, via advice entities, into release pipelines. Although insertion of crosscutting functionality into structured programming languages using the above-discussed advice-based methods, incorporation of crosscutting functionality into release pipelines by advice-based methods is not currently available. Advice-like mechanisms for release pipelines involves a significantly different design, a very different implementation, different functionalities, and different underlying concepts than those used for structured programming languages. In the following discussion and claims, rather than using the awkward phrase “advice-like,” the term “advice” is instead used to refer to the plug-in-implemented advice logic included in release pipelines by the currently disclosed subsystems and methods for incorporation of crosscutting functionality into release pipelines and to the various entities and representations employed by these subsystems and methods.

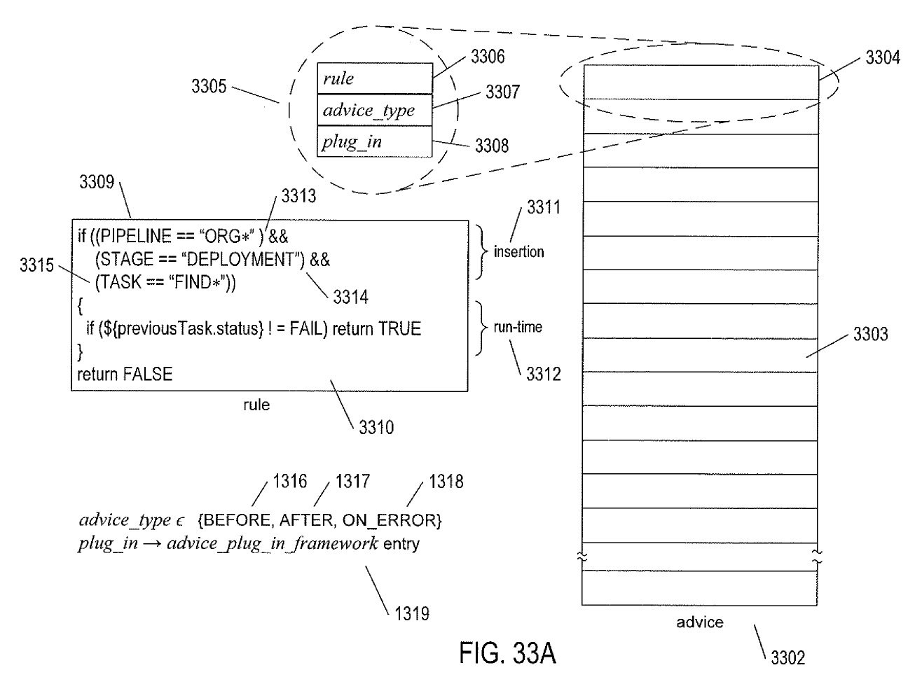

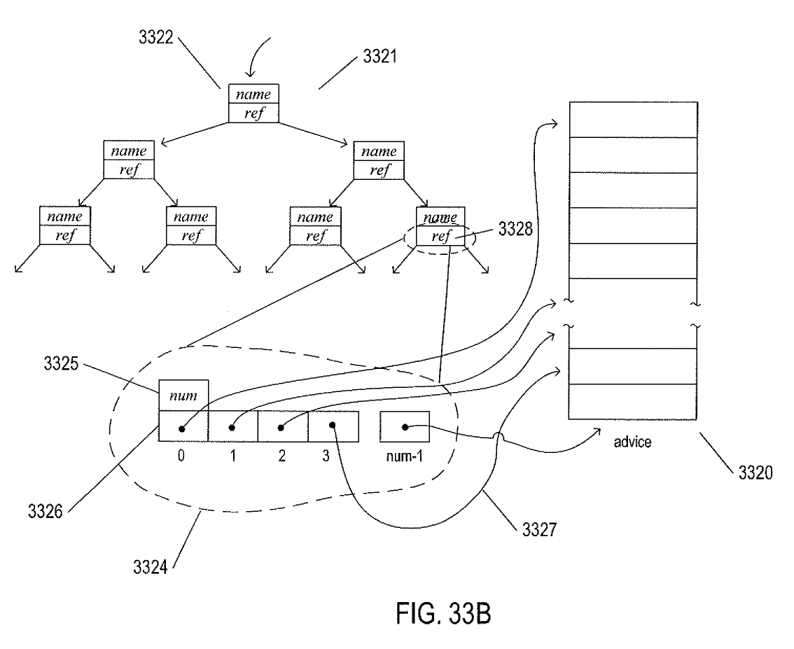

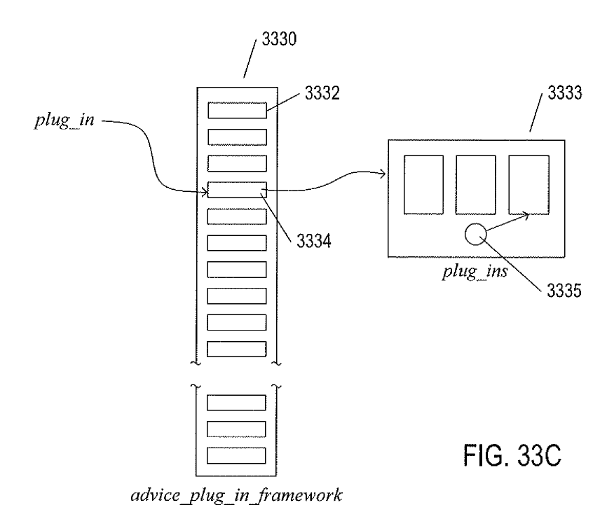

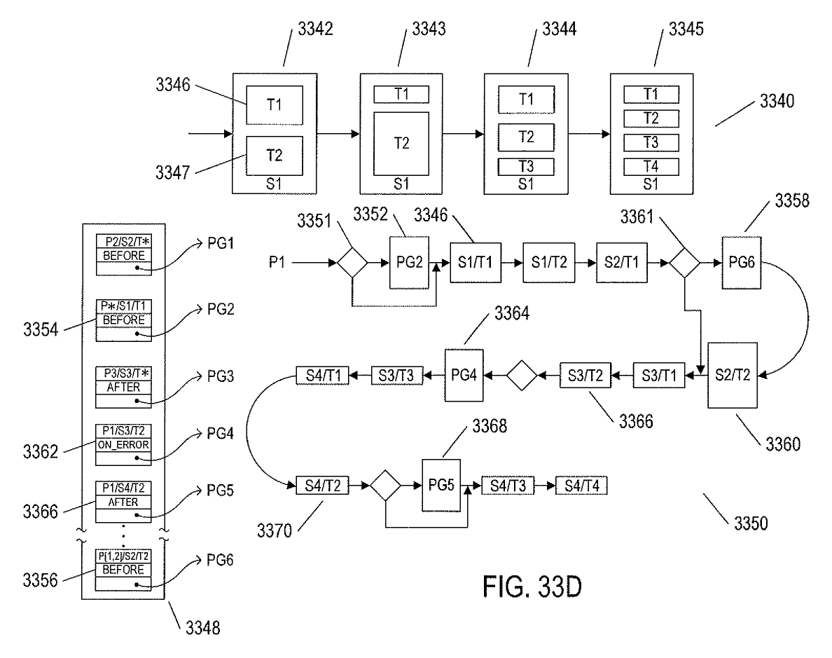

FIGS. 33A-D illustrate one implementation of advice mechanisms for release pipelines in a family of automated-application-release-management subsystems that support incorporation of advice-based crosscutting functionality into release pipelines. FIG. 33A illustrates the general approach to encoding advice entities within the automated-application-release-management subsystem. The advice entities are stored in an advice set or advice aggregation 3302. This set or aggregation may be implemented as one or more files, a database, and/or one or more data structures resident within memory and/or mass-storage devices. Logically, the advice set can be considered to be a set or table of entries, each entry represented by a rectangular cell, such as rectangular ceil 3303. Each entry, such as entry 3304, represents a particular advice entity and includes three fields shown in inset 3305: (1) a field rule 3306 that stores a rule; (2) a field advice_type that stores an indication of the type of the advice entity 3307; and (3) a field plug_in 3308 that stores a direct or indirect reference to a plug-in that implements the advice logic.

An example rule 3309 is shown in FIG. 33A. This example rule is encoded in C-like or C++-like pseudocode 3310 and includes an insertion portion 3311 and a run-time portion 3312. The insertion portion 3311 specifies the tasks to which the advice is added, including specification of all or part of a pipeline name 3313 all or part of a stage name 3314, and all or part of a task name 3315. In the pseudocode example, these designations are part of a Boolean expression that serves as the conditional portion of an if statement. The specifications of the pipeline, stage, and task names may include regular-expression-like symbols, such as wildcard characters and symbols denoting a choice between two or more alternative characters or phrases. In this way, a rule can be written to specify that logic corresponding to a particular advice entity be included in one or more different pipelines, one or more different stages within one or more pipelines, and one or more different tasks within one or more stages of one or more pipelines. The rule additionally includes a run-time portion 3312 that is also implemented, in the example rule 3309, as an if statement. The run-time portion of the rule is executed at runtime, during pipeline execution, and may use release-pipeline parameters in the same way that tasks may receive and output parameter values, as discussed above with reference to FIGS. 26A-28D. In the example rule 3309, the pseudocode 3310 returns the value TRUE when the logic corresponding to the advice entity is to be inserted and executed at a particular location within a workflow. Of course, there are many alternative ways for encoding rules, rather than using C or C++-like code, including using various types of scripts, using multiple fields, each including one or more Boolean expressions, using logic-programming assertions and using many other types of rule-logic encodings.

The advice types indicated by the values stored in the advice_type fields of advice-set entries include, in one implementation, the types (1) BEFORE 1316, indicating that the logic corresponding to an advice entity should be inserted prior to execution of a task; (2) AFTER 1317, indicating that the logic corresponding to an advice entity should be inserted following completion of a task; and (3) ON_ERROR 1318, indicating that the logic corresponding to an advice entity should be inserted following completion of a task and should be executed only when she task has returned an error code other than SUCCESS. In one implementation, the plus_in field of an advice-set entry references an advice_plug_in_framework entry 1319. In alternative implementations, the plug_in field may directly reference a plug-in stored within the automated-application-release-management subsystem.

FIG. 33B shows an indexing system that is used within one implementation of an automated-application-release-management subsystem to facilitate identifying advice entities relevant to a particular pipeline during pipeline execution. In FIG. 33B, the advice set or advice aggregation 3320 is again represented as a table of entries. A binary tree 3321 data structure is used to store an alphabetically ordered set of pipeline names that are included in the name fields of the binary-tree records, such as binary-tree record 3322. Each binary-tree record additionally includes a ref field, such as ref field 3323, the contents of which are illustrated in inset 3324. The ref field includes an indication of a number of references 3325 as well as references, stored in a variable array of references 3326, to advice-set entries, indicated in FIG. 33B by curved arrows, such as curved arrow 3327. Using an indexing method, such as the binary tree 3321, the pipeline-execution machinery of an automated-application-release-management subsystem can quickly identify the advice entities that may be potentially relevant to a pipeline to be executed. Of course, the index is generally dynamically updated whenever representations of new advice entities are entered into the advice set, whenever representations of advice entities are removed from the advice set, and whenever the insertion-portion of rules within advice entries are updated or modified. In alternative implementations, the advice set may be scanned for relevant rules without using indexes.

FIG. 33C illustrates a highly modularized plug-in framework for advice entities, similar to that used for pipeline stages, as discussed above with reference to FIG. 24. The advice_plug_in_framework 3330 includes multiple entries, such as entry 3332. Each entry references a set of one or more plug-ins, such as the set of one or more plug-ins 3333 referenced by entry 3334. As discussed above with reference to FIG. 24, a set of one or more plug-ins additionally includes a switch 3335 that indicates which of the alternative implementations of the logic for a particular advice entity is to be used during execution of a pipeline. This type of highly modular framework for plug-ins that implement logic for advice entities allows particular plug-ins to be selected from among one or more alternative plug-ins prior to execution of a particular release pipeline, with the selections specified by parameters, through UI dialogs, and/or using configuration files or scripts.

FIG. 33D schematically illustrates incorporation of advice logic into a release pipeline. In FIG. 33D, a particular release pipeline P1 3340 is shown at the top of the figure. This release pipeline includes four stages 3342-3345. Each stage includes multiple tasks, For example, stage S1 3342 includes the tasks T1 3346 and T2 3347. The advice set for the automated-application-release-management subsystem 3348 is represented in a column of advice-set entries on the left side of the figure. In the center of FIG. 33D, a schematic representation of the execution of pipeline P1 3350 is shown. The conditional elements, such as conditional element 3351, represent resolution of the run-time portion of advice rules that control, at run time, whether or not a following call to an advice-implementing plug-in, such as advice-implementing plug-in 3352, is made. Advice-set entry 3354 is applicable to task T1 of stage S1 for all pipelines having the name P followed by 0, 1, or more characters, as indicated by the symbols “P*” in the rule field. Therefore, a call to plug-in P2, referenced by this advice-set entry, is inserted into the pipeline-execution flow 3352 prior to the task S1/T1 3346, the first task in the first stage of pipeline P1. The conditional 3351 resolves the run_time portion of the rule (not shown in FIG. 33D) specified in advice-set entry 3354. When the run-time portion of the rule indicates that the advice should be called, then a call is made to plug-in 3352. Similarly, advice-set entry 3356 specifies that a call to plug-in PG6 3358 needs to be made prior to execution of the second task of the second stage of the pipeline 3360. Conditional 3361 represents resolution of the run-time portion of the rule in advice-set entry 3356 (not shown in FIG. 33D). Advice-set entry 3362 specifies a conditional call to plug-in PG4 3364 following execution of the second task of the third stage 3366 and advice-set entry 3366 specifies that a conditional call to plug-in PG5 3368 is to be made following execution of the second task of the fourth stage 3370. Thus, the entries of the advice set are used to insert conditional calls to plug-ins corresponding to advice entries into specified locations of the execution flow for the pipeline. A particular rule may not include a run-time portion, and therefore the corresponding plug-in may be inserted non-conditionally into the workflow in such cases.

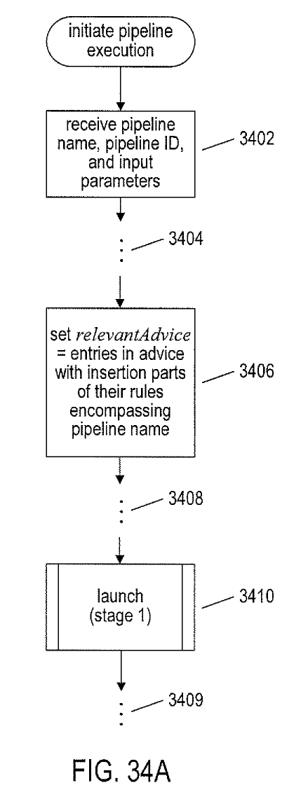

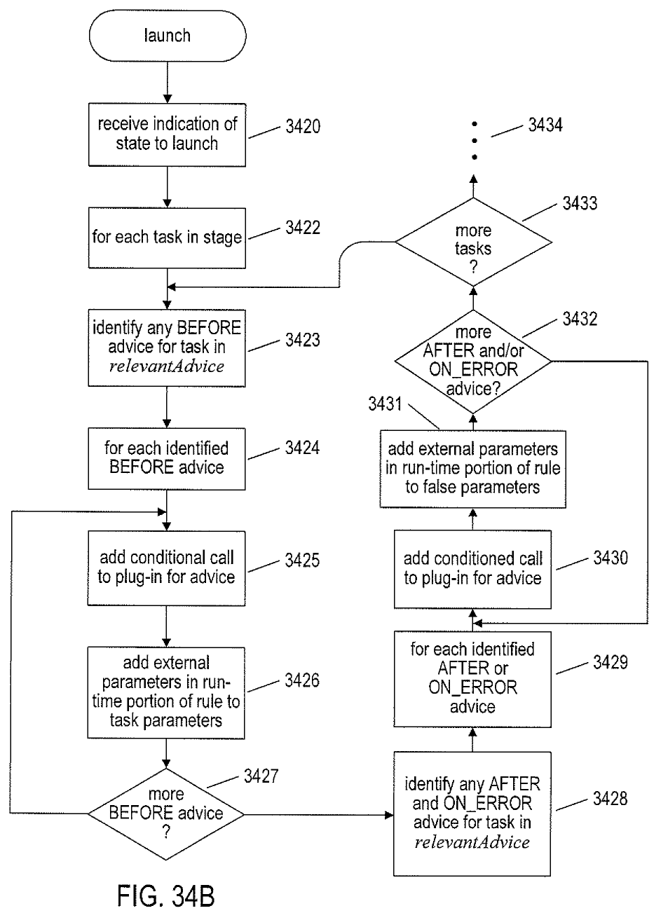

FIGS. 34A-34B provide control-flow diagrams that illustrate incorporation of advice logic into a release pipeline within an automated-application-release-management subsystem. FIG. 34A shows additional steps in the initiate-pipeline-execution routine discussed above with reference to FIG. 28C. In step 3402, the initiate-pipeline-execution routine receives the name for a pipeline to execute, an ID for the pipeline, and input parameters. Ellipses 3404 indicate various additional steps, such as those shown in FIG. 28C. In step 3406, the entries in the advice set with rule insertion parts that encompass the received pipeline name, using, in one implementation, a search of the index 3321 associated with the advice set 3320, discussed above with reference to FIG. 33B, are inserted into a local set relevantAdvice. Ellipses 3408-3409 and step 3410 indicate additional previously discussed steps as well as the call to the launch routine previously discussed with reference to step 2830 in FIG. 28C.

FIG. 34B provides a control-flow diagram for the launch routine called in step 3410 of FIG. 34A and previously discussed with reference to FIG. 28D. In step 3420, the launch routine receives an indication of a stage of a currently executed pipeline to launch. In the outer for-loop steps 3422-3433, each task in the stage is considered for insertion of advice logic. In step 3423, advice entities in the set relevantAdvice that are specified for insertion prior to the currently considered task are identified. In the first inner for-loop of steps 3424-3427, for each of the identified advice entries, a conditional call to the plug-in referenced by the advice entry is added to the task, in step 3425 and, in step 3426, any external parameters used in the run-time portion of the advice rule are added to the list of input task parameters. Similarly, in step 3428, any AFTER and ON_ERROR advice for the currently considered task are identified in the advice set relevantAdvice. Then, in the inner for-loop of steps 3439-3432, conditional calls to the plug-ins referenced by the identified advice are added to the task following the body of the currently considered task and any external parameters in the run-time portions of the added advice are added to the input task parameters for the task. Again, advice entries that lack run-time rule portions are inserted non-conditionally into the task. Ellipses 3434 indicate that the remaining steps in the launch routine, previously discussed with reference to FIG. 28D are then executed in order to launch execution of the first task of the stage.

Although the present invention has been described in terms of particular embodiments it is not intended that the invention be limited to these embodiments. Modifications within the spirit of the invention will be apparent to those skilled in the art. For example, any of many different implementation and design parameters may be altered to generate a variety of alternative implementations for the advice-insertion mechanisms, including operating system, hardware platform, virtualization layer, control structures, data structures, modular organization, programming languages, and other such design and implementation parameters. In the described implementation, tasks are modified, during launch of a stage as a pipeline is executed, to incorporate additional calls to advice-logic-implementing plug-ins. In alternative implementations, the advice logic may be inserted as separate tasks into stages rather than as modifications to tasks.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An automated-application-release-management subsystem within a distributed computer system having multiple servers, data-storage devices, and one or more internal networks, the automated-application-release-management subsystem comprising:
a dashboard user interface;
an automated-application-release-management controller that controls execution of release pipelines that each includes one or more stages that each includes one or more tasks;
an interface to a workflow-execution engine;
an artifact-storage-and-management subsystem; and
advice entities that represent cross-cutting functionalities that are incorporated, by the automated-application-release-management controller, at particular points in one or more release pipelines for execution by the workflow-execution engine.

2. The automated-application-release-management subsystem of claim 1 that is further incorporated in a workflow-based distributed-computer-system-management system that additionally includes an infrastructure-management-administration subsystem and the workflow-execution engine.

3. The automated-application-release-management subsystem of claim 1 further including an advice set that stores entries that represent advice entities, the advice set implemented as one or more of:
one or more files;
one or more files and one or more associated indexes;
a database;
data structures stored in memory and/or mass-storage devices.

4. The automated-application-release-management subsystem of claim 3 wherein each advice-set entry includes a rule, a type, and a reference that is resolved to the location of a plug-in that implements advice logic.

5. The automated-application-release-management subsystem of claim 4 wherein the rule within an advice-set entry indicates one or more target tasks within one or more stages within one or more pipelines.

6. The automated-application-release-management subsystem of claim 5 wherein the type within the advice-set entry indicates whether a plug-in, the location of which is obtained by resolving the reference within the advice-set entry, is incorporated at a point in the one or more release pipelines before or after each target task.

7. The automated-application-release-management subsystem of claim 5 wherein the type within the advice-set entry further indicates whether the plug-in, the location of which is obtained by resolving the reference within the advice-set entry, is incorporated at a point in the one or more release pipelines after each target task and called by the workflow execution engine when the target task does not successfully execute.

8. The automated-application-release-management subsystem of claim 4 wherein the rule within an advice-set entry indicates whether or not the plug-in, the location of which is obtained by resolving the reference within the advice-set entry, is called during execution of a pipeline by the workflow-execution engine.

9. The automated-application-release-management subsystem of claim 4 wherein the rule within an advice-set entry includes a logic expression that includes one or more pipeline parameters that include parameters input to and output by tasks.

10. The automated-application-release-management subsystem of claim 4 wherein the reference within an advice-set entry contains the location of a plug-in.

11. The automated-application-release-management subsystem of claim 4
wherein the reference within an advice-set entry contains the location of an advice-plug-in-framework entry that references a set of one or more plug-ins that represent alternative implementations of the advice logic; and
wherein the reference resolves to a particular plug-in of the set of one or more plug-ins under control of one or more of:
one or more parameters,
one or more configuration files, and
a dashboard-user-interface dialogue.

12. A method that incorporates cross-cutting functionalities into release pipelines executed by an automated-application-release-management subsystem, operating within a distributed-computer system having multiple servers, data-storage devices, and one or more internal networks, modular, the method comprising:
storing advice entries that represent cross-cutting functionalities in an advice set; and
incorporating, by an automated-application-release-management controller, cross-cutting functionalities at particular points in one or more release pipelines for execution by the workflow-execution engine using the advice set.

13. The method of claim 12 wherein the automated-application-release-management subsystem comprises:
a dashboard user interface;
the automated-application-release-management controller;
an interface to the workflow-execution engine within the cloud-computing facility;
an artifact-storage-and-management subsystem;
an infrastructure-management-and-administration subsystem;
the advice set; and
the workflow-execution engine.

14. The method of claim 12 wherein the advice set implemented as one or more of:
one or more files;
one or more files and one or more associated indexes;
a database;
data structures stored in memory and/or mass-storage devices.

15. The method of claim 12 wherein each advice-set entry includes a rule, a type, and a reference that is resolved to the location of a plug-in that implements advice logic.

16. The method of claim 15
wherein the rule within an advice-set entry indicates one or more target tasks within one or more stages within one or more pipelines;
wherein the type within the advice-set entry indicates whether a plug-in, the location of which is obtained by resolving the reference within the advice-set entry, is incorporated at a point in the one or more release pipelines before or after each target task; and
wherein the type within the advice-set entry further indicates whether the plug-in, the location of which is obtained by resolving the reference within the advice-set entry, is incorporated at a point in the one or more release pipelines after each target task and called by the workflow execution engine when the target task does not successfully execute.

17. The method of claim 12 wherein the rule within an advice-set entry indicates whether or not the plug-in, the location of which is obtained by resolving the reference within the advice-set entry, is called during execution of a pipeline by the workflow-execution engine.

18. The method of claim 4 wherein the rule within an advice-set entry includes a logic expression that includes one or more pipeline parameters that include parameters input to and output by tasks.

19. The method of claim 4 wherein the reference within an advice-set entry contains one of:
the location of a plug-in; and
the location of an advice-plug-in-framework entry that references a set of one or more plug-ins that represent alternative implementations of the advice logic.

20. Computer instructions, stored within one or more physical data-storage devices, that, when executed on one or more processors within a distributed computer system having multiple servers, data-storage devices, and one or more internal networks, control an automated-application-release-management subsystem having a dashboard user interface, an automated-application-release-management controller, an interface to the workflow-execution engine within the cloud-computing facility, an artifact-storage-and-management subsystem, an infrastructure-management-and-administration subsystem, an advice set, and a workflow-execution engine to:
store advice entries that represent cross-cutting functionalities in the advice set; and
incorporate, by the automated-application-release-management controller, cross-cutting functionalities at particular points in one or more release pipelines for execution by the workflow-execution engine using the advice set.
